(19) United States
(12) Patent Application Publication
(10) Pub. No.: US 2002/0051215 A1
(43) Pub. Date: May 2, 2002

(54) Methods and apparatus for transporting and positioning film in a digital film processing system

(76) Inventors: Michael R. Thering, Austin, TX (US); Robert S. Young JR., Austin, TX (US); George G. Mooty, Austin, TX (US); Paul K. Highley, Austin, TX (US); Richard A. Coleman, Austin, TX (US); Roy M. Patterson, Austin, TX (US); Lee M. Jones, Austin, TX (US)

Correspondence Address: DINSMORE & SHOHL, LLP, 1900 CHEMED CENTER, 255 EAST FIFTH STREET, CINCINNATI, OH, 45202, US

(21) Appl. No.: 09/750,824

(22) Filed: Dec. 28, 2000

Related U.S. Application Data
(60) Provisional application No. 60/173,653, filed on Dec. 30, 1999.
(60) Provisional application No. 60/174,042, filed on Dec. 30, 1999.
(60) Provisional application No. 60/174,041, filed on Dec. 30, 1999.
(60) Provisional application No. 60/174,084, filed on Dec. 30, 1999.
(60) Provisional application No. 60/174,040, filed on Dec. 30, 1999.
(60) Provisional application No. 60/174,189, filed on Dec. 30, 1999.

(51) Int. Cl. H04N 1/21

(52) U.S. Cl. 358/302

(57) ABSTRACT

A digital film processing system is provided. Each scanning module in the system has a removable mounting panel to which the scanning and transportation components are secured. An opening or door can be provided between the modules to compensate for film buckling. The film can be tensioned during scanning for control over its position. Tape can be attached to side edges of the film, and the tape can be moved through the system, avoiding contact with the film. Also, a belt transport system can be utilized to contact the film (or attached tape) only on the lateral edges. The film may be threaded through the system by using a leader attached to the lead edge of the film. To transport the film and leader, a transport mechanism having a roller connecting a pair of sprockets may be used, and a single drive unit may be provided to pull the film.

This application claims the benefit of U.S. Provisional Application No. 60/173,653 filed Dec. 30, 1999, U.S. Provisional Application No. 60/174,042 filed Dec. 30, 1999, U.S. Provisional Application No. 60/174,041 filed Dec. 30, 1999, U.S. Provisional Application No. 60/174,084 filed Dec. 30, 1999, U.S. Provisional Application No. 60/174,040, filed Dec. 30, 1999, and U.S. Provisional Application No. 60/174,189, filed Dec. 30, 1999, the entire disclosures of which are hereby incorporated herein by reference.

### TECHNICAL FIELD

The present invention relates generally to film scanning, and more particularly to methods and apparatus for transporting, positioning, and scanning film in digital film scanning systems.

### BACKGROUND OF THE INVENTION

Color photographic film generally comprises three layers of light sensitive material that are separately sensitive to red, green, and blue light. During conventional color photographic film development, the exposed film is chemically processed to produce dyes in the three layers with color densities directly proportional to the blue, green and red spectral exposures that were recorded on the film in response to the light reflecting from the photographed scene. Yellow dye is produced in the top layer, magenta dye in the middle layer, and cyan dye in the bottom layer, the combination of the produced dyes revealing the latent image. Once the film is developed, a separate printing process can be used to record photographic prints, using the developed film and photographic paper.

In contrast to conventional film development, digital film development systems, or digital film processing systems, have been proposed. One such system involves chemically developing exposed film to form scene images comprised of silver metal particles or grains in each of the red, green, and blue recording layers of the film. Then, while the film is developing, it is scanned using electromagnetic radiation, such as light with one predominant frequency, preferably in the infrared region. In particular, as the film develops in response to chemical developer, a light source is directed to the front of the film, and a light source is directed to the back of the film. Grains of elemental silver developing in the top layer (e.g., the blue sensitive layer) are visible from the front of the film by light reflected from the front source; however, these grains are substantially hidden from the back of the film. Similarly, grains of elemental silver developing in the bottom layer (e.g., the red sensitive layer) are visible from the back of the film by light reflected from the back source; however these grains are substantially hidden from the front. Meanwhile, grains of elemental silver in the middle layer (e.g., the green sensitive layer) are substantially hidden from the light reflected from the front or back; however, these grains are visible by any light transmitted through the three layers, as are those grains in the other two layers. Thus, by sensing, for each pixel location, light reflected from the front of the film, light reflected from the back of the film, and light transmitted through the film, three measurements can be acquired for each pixel. The three measured numbers for each pixel can then be solved for the three colors to arrive at three color code values for each pixel, and the plurality of colored pixels can then be printed or displayed to view the image.

If desired, such scanning of each frame on the film can occur at multiple times during the development of the film. Accordingly, features of the frame which may appear quickly during development can be recorded, as well as features of the frame which may not appear until later in the film development. The multiple digital image files for each frame can then be combined to form a single enhanced image file.

In order to obtain multiple scans of the same image during digital film development, multiple scanning devices could be utilized, each scanning device scanning the film at a different development time of the film. It is desirable that such a multiple-scanner system is easily modifiable, upgradable, and serviceable, to suit the needs of the user. For example, there is a need for a digital film development system which allows for quick and simple addition, removal, and/or replacement of components in the system, with minimal delay in system downtime.

Transporting each film strip in a digital film development system is generally more problematic than with conventional film transport systems. In particular, the film should be smoothly and efficiently transported to provide optimum digital image results. Since the optical systems used in digital film development systems may have a relatively narrow depth of field, it is also important to carefully control the position, orientation and movement of the portion of the film being scanned, i.e., precisely locating and maintaining the film in a proper orientation as it is being scanned, and to avoid touching or scratching the portion of the film containing the latent image. Jamming or buckling of the film as it is being transported through the system can cause a malfunction, and thus should also be avoided or accommodated. In addition, it is preferred that the transport system allow the portion of the film containing the latent image to be fully covered with a substantially uniform layer of developer during the development, while minimizing the transfer of developer to the transport equipment. In addition, the transport system optimally can handle a variety of film types and sizes without masking any portion of the film containing a latent image during scanning. There also remains a need, particularly when multiple scanning devices are being used, for a film transportation system which does not require repeated manual film threading through the various scanning devices.

### SUMMARY OF THE INVENTION

An advantage of at least one embodiment of the invention is that the positioning of film is tightly controlled as it is transported and scanned.

In at least one embodiment of the invention, an easily upgradable and serviceable digital film processing system is provided.

An advantage of at least one embodiment of the invention is that a single digital film development system can be used to process a variety of film sizes.

One advantage of at least one embodiment of the invention is that information encoded along film side edges can be scanned and utilized by a digital film processing system.

An advantage of at least one embodiment of the invention is that manual threading of film through a digital film development system is minimized.

Another advantage of at least one embodiment of the invention is that multiple drive equipment is not necessary for driving film through a digital film development system.

In accordance with one aspect of the invention, a digital film development is provided comprising a first film scanning module adapted to apply radiation to film and to sense radiation from the film, and a second film scanning module adapted to apply radiation to the film and to sense radiation from the film. A buffer assembly may be provided between the first and second scanning modules, and the buffer assembly can include an opening through which the film may travel. The components of each module may be mounted to a mounting member and the mounting member may be mounted to a frame within a housing. Each mounting member can be disconnected from the frame to remove the module from the system.

According to another aspect of the invention, a transport system for photographic film is provided that moves exposed film through a processing device so that access to the central portion of the film is substantially unhindered. This allows the central portion of the film, the portion of the film containing latent images, to be freely accessed for processing. The transport system of the present invention also avoids contact between the central portion of the film and the processing equipment, eliminating process scratches on this important portion of the film. The transport system of the invention provides a virtually unimpeded light path to the central portion of the film, and is particularly advantageous for digital film processing. The lack of contact between the processing equipment and the central portion of the film further advantageously avoids contamination from developer that is applied to the central portion of the film. The transport system of the invention also provides flexibility to process a variety of film sizes.

When used as a scanning unit in digital film processing, one aspect of the invention provides precise control of the position and orientation of the portion of the film being scanned. Such control eliminates unintended movement of the film during critical portions of the development process and improves the resulting scanned image

According to another aspect of the invention, a method for transporting film through a scanning system is provided. The method comprises attaching a film strip to a tape strip, engaging only the tape strip, and moving the tape strip past a scanning mechanism to create a digital image file.

In accordance with another aspect of the invention, a method for moving film through a digital film development system is provided. In the method, a trailing edge of a leader strip is attached to a leading edge of a film strip, and the leader is threaded through a film transport system which moves the leader and attached film. A developer is applied to the film to cause the film to begin to develop. Radiation is applied to the developing film and radiation is also sensed from the developing film.

According to another aspect of the invention, a transport mechanism is provided for transporting film and an attached leader. The mechanism includes a pair of opposing sprockets having teeth which are adapted to engage sprocket holes on a film strip. The mechanism also includes a roller connecting the sprockets and adapted to support a leader strip. The leader is preferably narrower than the film and is self-centered by the roller.

In accordance with another aspect of the invention, a digital film development system is provided comprising a developer dispenser configured to apply developer to film, a source configured to apply radiation to the developing film, and a sensor configured to sense radiation from the developing film. A single drive mechanism is provided to move the developing film past the source and sensor.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

While the specification concludes with claims particularly pointing out and distinctly claiming the invention, it is believed that the same will be better understood from the following description taken in conjunction with the accompanying drawings in which like reference numerals indicate corresponding structure throughout the figures.

FIG. 1 is a perspective view of an exemplary embodiment of a digital film development system which can be used with the methods and apparatus of the present invention;

FIG. 2 illustrates the exemplary operation of the digital film development system of FIG. 1;

FIG. 3 is a side view of an exemplary modular digital film development system having multiple scanning stations or modules in accordance with principles of the present invention;

FIG. 4 is a perspective view of an exemplary embodiment of a modular digital film development system made according to principles of the present invention;

FIG. 5 is a side view of the digital film development system of FIG. 4;

FIG. 6 is an exploded perspective view of an exemplary film buffer assembly having a trap door (shown in the closed position), which can be used between scanning modules of a modular digital film development system, according to principles of the present invention;

FIG. 7 is an exploded perspective view of the film buffer assembly of FIG. 6, with the trap door shown in the open position;

FIGS. 8a and 8b show the rotational movement of the trap door of FIG. 6 between the closed and open positions;

FIG. 9 is a perspective view of an exemplary arcuate film transportation and guidance assembly for use in a digital film development system, and made in accordance with principles of the present invention;

FIG. 10 is a partially-exploded perspective view of an alternative embodiment of a film transportation and guidance assembly for use in a digital film development system, according to principles of the present invention;

FIG. 11 is side view of an alternative embodiment of a film transportation and buffer system, made according to principles of the present invention;

FIG. 12 is a side view of another exemplary embodiment of a film transportation system, in accordance with principles of the present invention;

FIG. 13 is a schematic side view of an exemplary digital film development system made in accordance with principles of the present invention;

FIG. 13A is a diagrammatic illustration depicting the manner in which an exemplary belt assembly, constructed in accordance with an aspect of the invention, contacts a film strip being transported;

FIG. 13B is a diagrammatic side view illustration of an alternative embodiment of a pair of transport belts capturing a single side of a film strip, made in accordance with principles of the invention;

FIG. 13C is a diagrammatic illustration of a further alternative embodiment of one aspect of the invention depicting a system for multiple passes of a film strip past a single processing unit;

FIG. 14 is a end elevational view of one of the digital processing module depicted in FIG. 13;

FIG. 15 is a partial cross-sectional view of the digital processing module of FIG. 14, taken across cutting plane A-A;

FIG. 16 is a schematic representation of an alternative arrangement of a controlling the position and orientation of film as it is being processed;

FIG. 16A is a schematic side view representation of the arrangement of FIG. 16;

FIG. 17 is a schematic representation of a further alternative arrangement for controlling the position and orientation of film as it is being processed.

FIG. 18 is a top view of an exemplary film transport tape, with attached film strips, according to principles of the present invention;

FIG. 19 is a cross-sectional view of an exemplary film transport tape with attached film and developer, as the tape is moved by wheels, according to principles of the present invention;

FIG. 20 is a cross-sectional view showing the application of film to an exemplary film transport tape, in accordance with principles of the present invention;

FIG. 21 is a cross-sectional view showing the application of film edges to a pair of exemplary film transport tapes, in accordance with principles of the present invention;

FIG. 22 is a cross-sectional view showing the application of film edges to a pair of exemplary transport tapes which are folded over, according to principles of the present invention;

FIG. 23 is a schematic diagram illustrating an exemplary digital film development system which utilizes film transport tape for transporting film;

FIG. 24 is a perspective view of an exemplary digital film development system utilizing a leader for threading and transporting the film, in accordance with further principles of the present invention;

FIG. 25 is a perspective view of the system of FIG. 24, where the leader is looped back to re-connect with the film according to another aspect of the present invention;

FIG. 26 is a perspective view of the system of FIG. 24, where separate leaders are spliced to the leading edge and trailing edge of the film, according to another aspect of the present invention;

FIG. 27A is a perspective view of an exemplary self-centering film roller, made according to principles of the present invention;

FIG. 27B is a side view of the roller of FIG. 27A;

FIG. 27C is an end view of the roller of FIG. 27A;

FIG. 28 is a schematic view of an exemplary digital film development system which utilizes a spliced film leader and which includes vertical transport sections for increasing film development time, according to principles of the present invention; and

FIG. 29 is a schematic diagram illustrating an exemplary digital film development system having a single scanning station and a pair of bi-directional capstan drives.

### DETAILED DESCRIPTION OF EXEMPLARY EMBODIMENTS

In general, the invention relates to digital processing of film, and to modules, components, and/or methods for use in transporting and scanning film to carry out such digital processing.

According to one aspect, a modular digital film processing system is provided which includes multiple scanning modules to obtain digital images from developing film. Each module has a mounting panel or housing to which the scanning and transportation components are secured. Accordingly, each module can be easily moved into and out of the system by handling the mounting panel or housing. Moreover, the modules have substantially identical components and configurations such that modules can be removed, replaced, or added as desired by the user, providing easy upgrading and maintenance.

A buffer assembly can be provided between the modules to compensate for buckling or jamming of the film which can be caused by speed differential between the modules. The buffer assembly can include a trap door mechanism which is opened to reveal an opening through which the film can freely travel. In this way, any undesired pressure or tension on the film can be relieved.

A film transportation and guidance assembly for a film scanning system is also provided, which tensions the film as it is being scanned, providing tight control over the film position and optimum scanning results. In one embodiment, the film is tensioned by providing separate drive wheels which operate at differing rotational speeds. A slip clutch can be provided to avoid over tensioning of the film. In this exemplary embodiment, the film is formed into an arc by driving it over an arcuate film bridge as it is tensioned, to provide optimum film control.

Another aspect of the present invention generally relates to a transport system for photographic film. In one of the exemplary forms, the invention uses two pairs of spaced belts, one above and the other below a film strip. The two pairs of belts are engaged against only the lateral portions of the film, leaving the central portion of the film that contains latent images untouched. This not only avoids scratching of the portion of the film containing images, it facilitates deposit of a developer on the central portion of the film and permits the central portion of the film to be exposed to light, making the transport system particularly advantageous for digital film processing. Another aspect of the invention particularly advantageous for digital film processing involves urging the film against a rotating accurate control surface during scanning. The control surface defines an image plane and insures that the film is positioned and orientated in a carefully controlled plane during the scanning. Such positioning and orientation is particularly significant when, as is the typical case in digital processing equipment, the system optics have a relatively narrow depth of field.

According to another aspect of the present invention, a method and system is provided for transporting film through a scanning system by attaching tape to the film. Generally, the tape can then be engaged and moved by a film transport system. As the tape strip is moved past a scanning mechanism, a digital image is created from the film which is attached to the tape. Because the film is not contacted, developer can be applied to uniformly to the entire surface of the film. Also, it is preferred that the tape is wide enough to accommodate film strips of various widths or formats, allowing the same scanning and transportation system to be used with many different film types. The tape is preferably transparent to the radiation provided by the scanning mechanism, so as not to interfere with the scanning process.

Another aspect of the present invention generally relates to a method for transporting film through a digital film development system using a leader. The trailing edge of the leader can be attached to a leading edge of the film, and the leader can be threaded through the film transport system. The film transport system moves the leader and the attached film. Developer is applied to the film to cause the film to develop. During scanning, radiation is applied to the developing film and radiation is sensed from the developing film to create a digital image. The leading edge of the leader may be attached to the trailing edge of the film to form a continuous loop. Alternatively, a separate leader or a new film strip can be attached to the trailing edge of the film. To center the leader, a roller mechanism having a crown roller and a pair of sprockets may be used. The sprockets transport the film while the narrower leader is supported and centered by the crown roller. A single drive unit may be utilized to pull the film and attached leader through the digital film development system, to avoid the need for multiple drive units and the risk of film jamming.

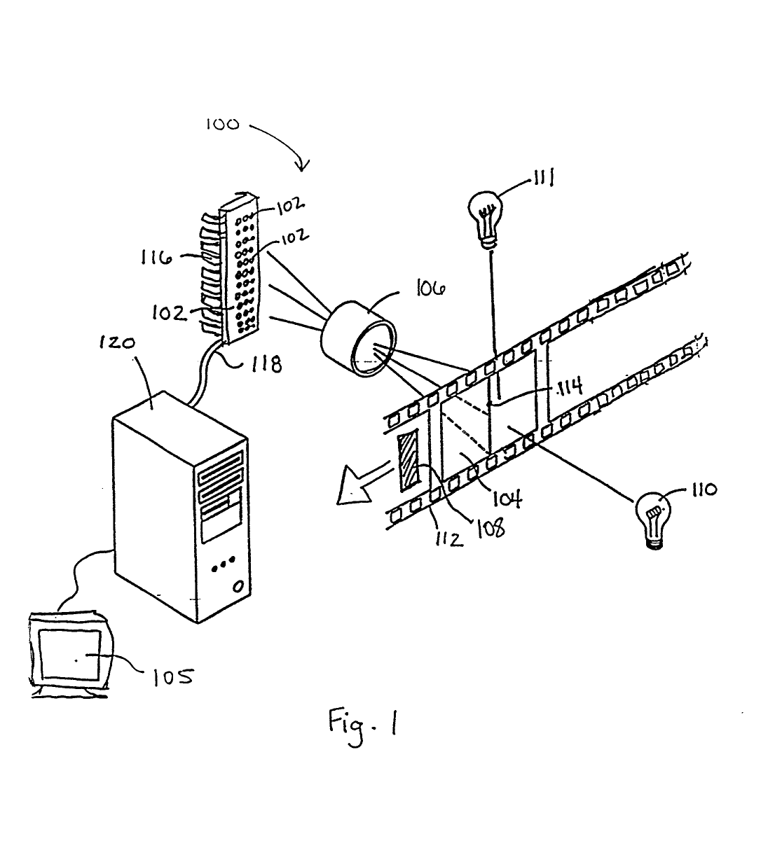

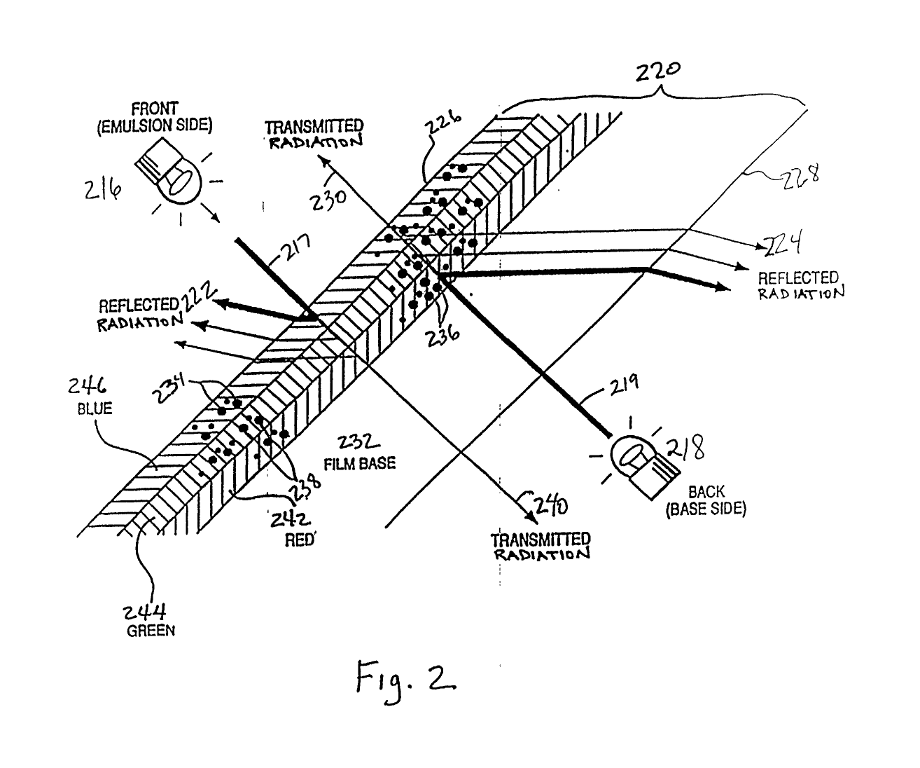

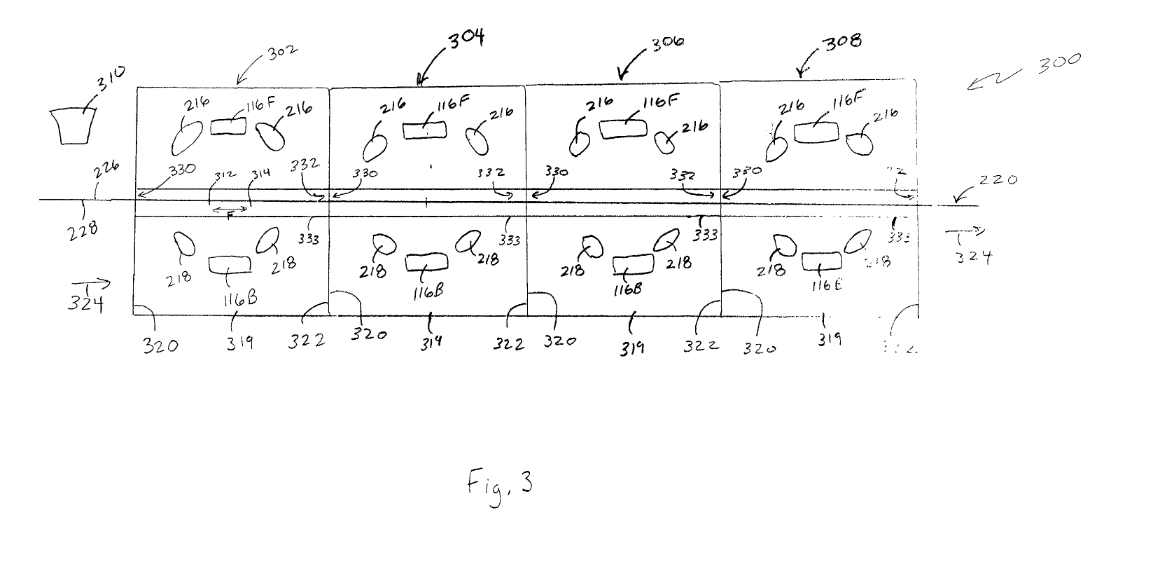

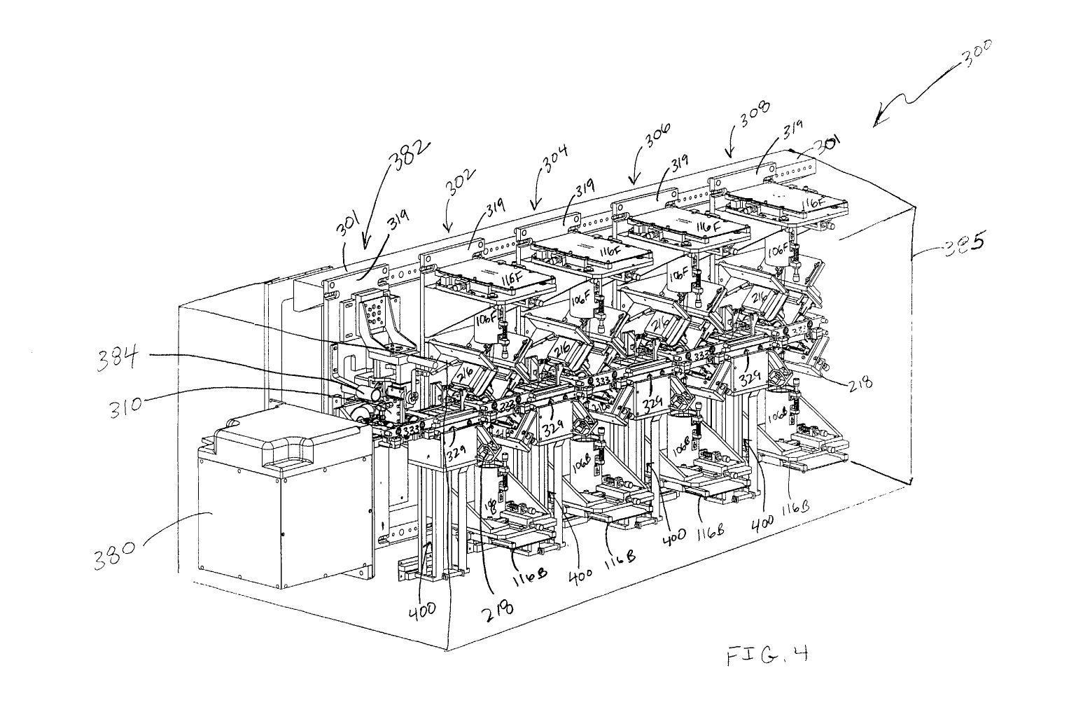

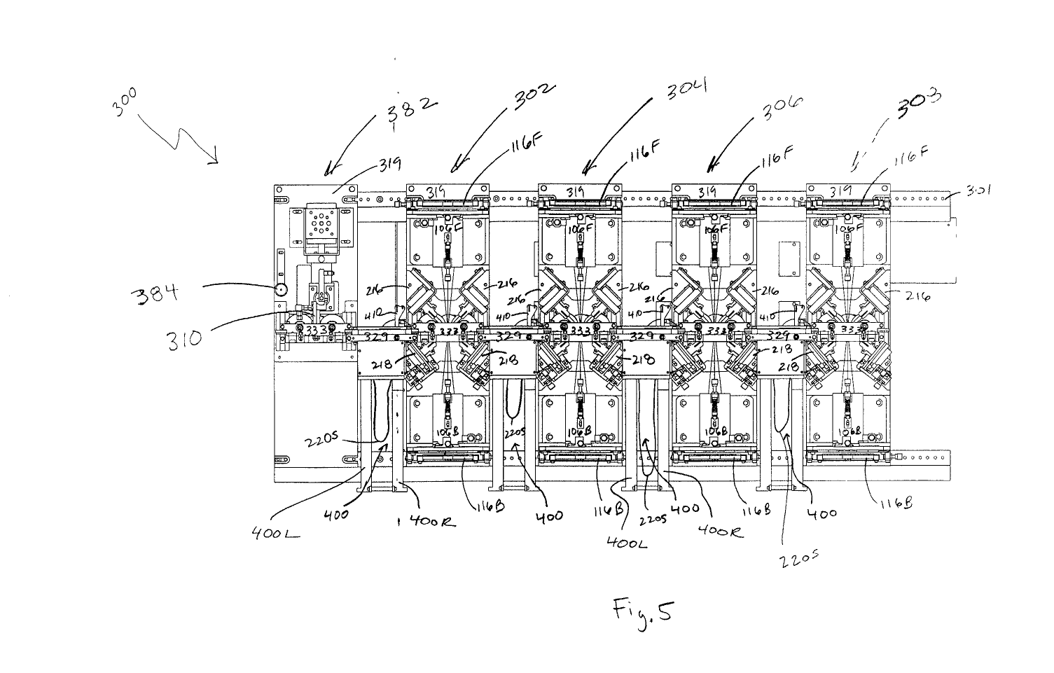

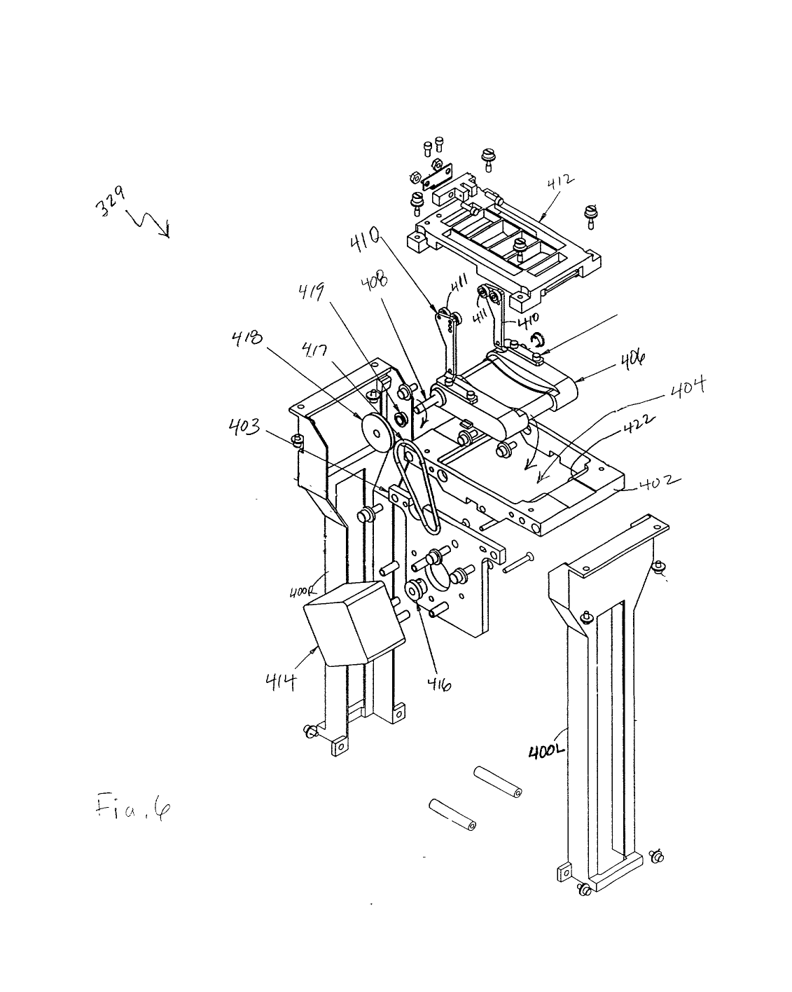

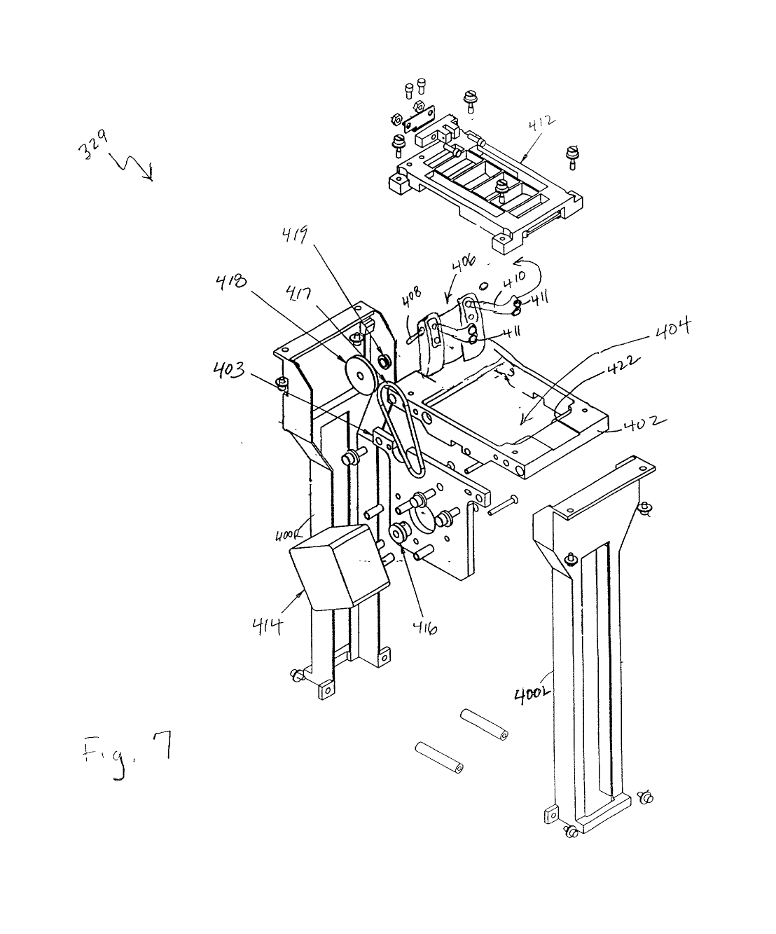

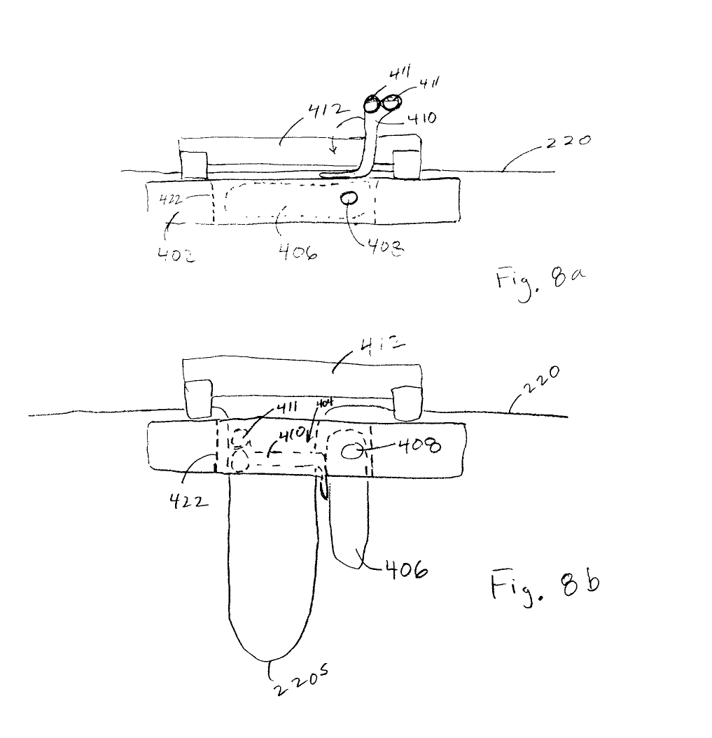

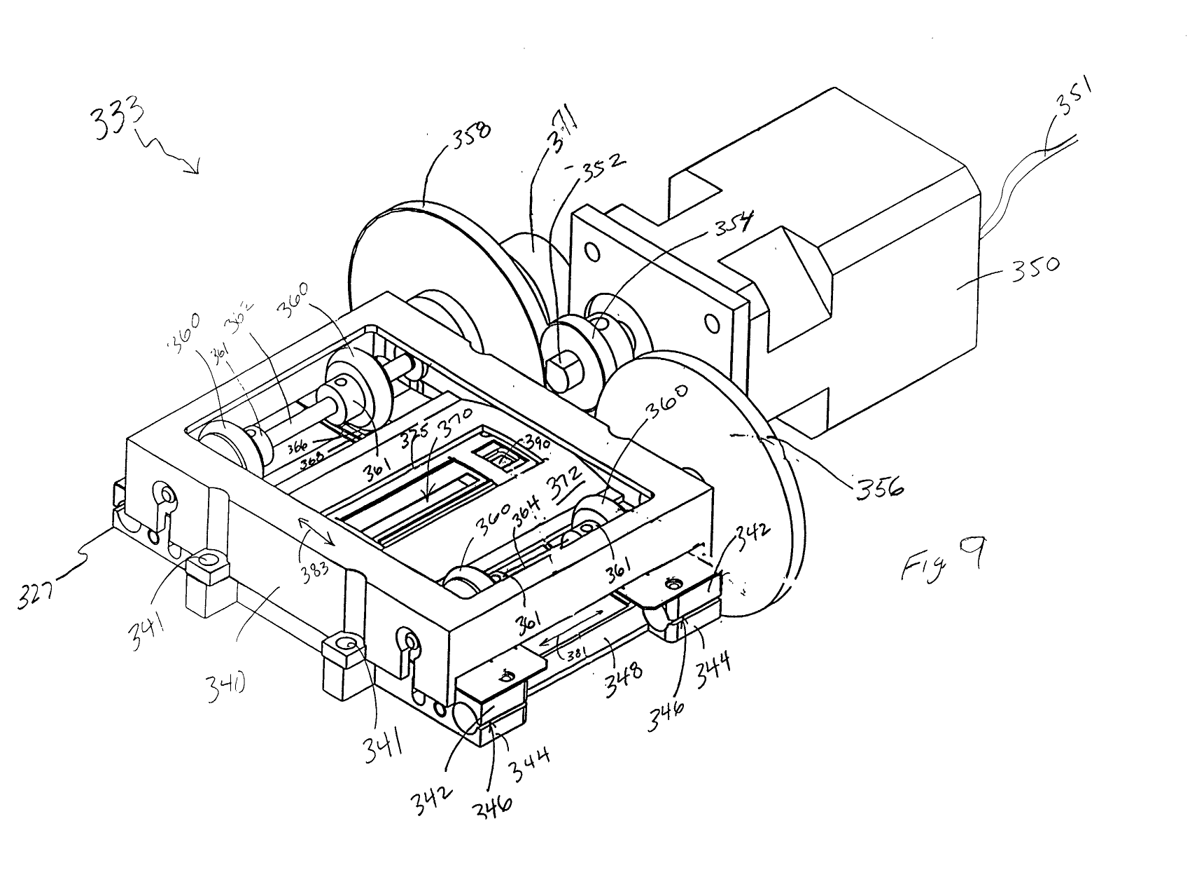

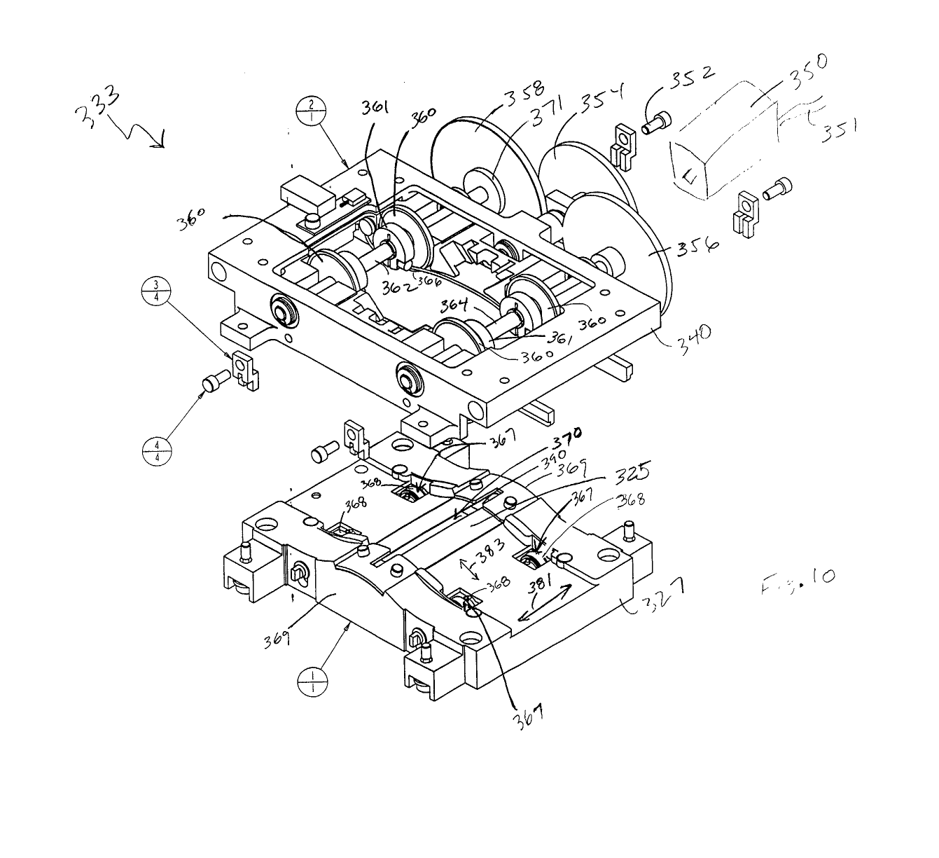

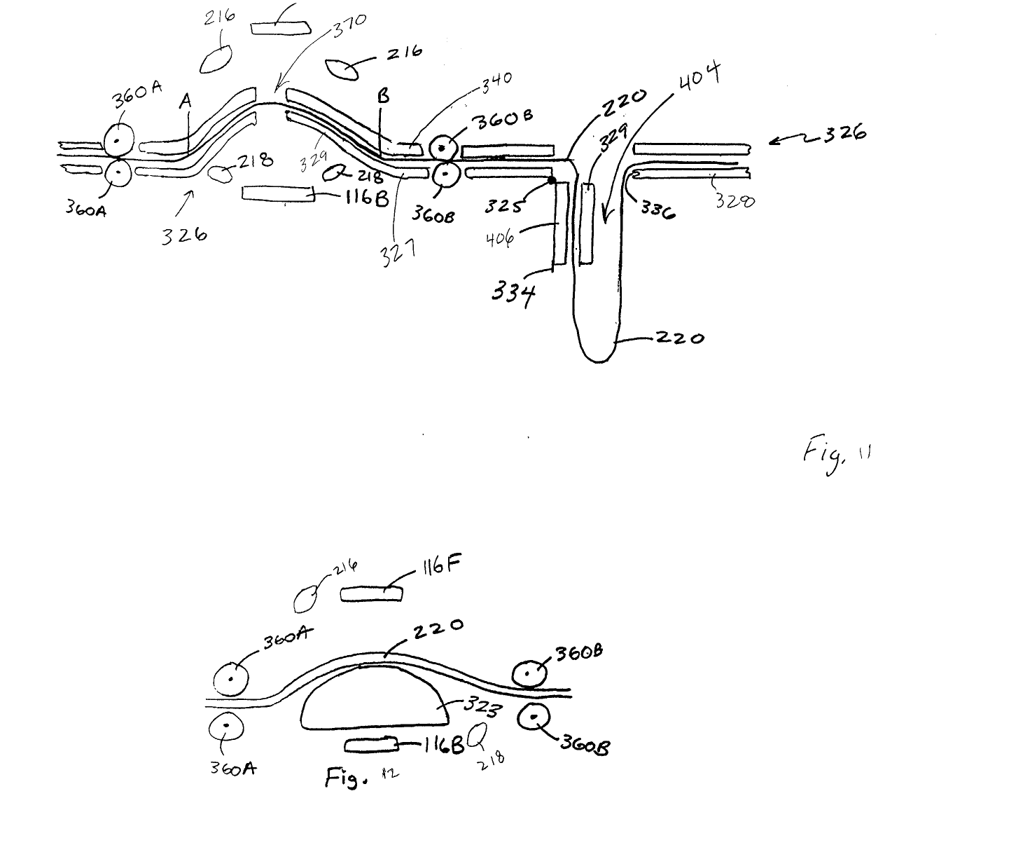

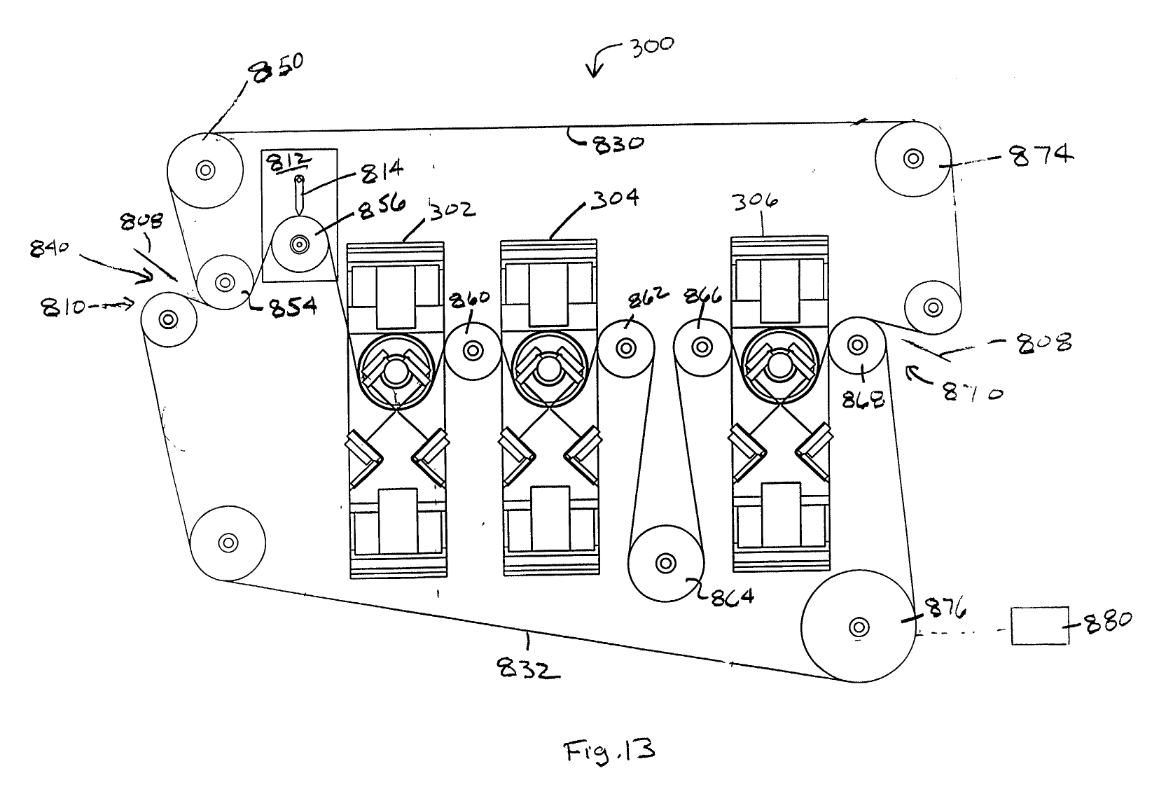

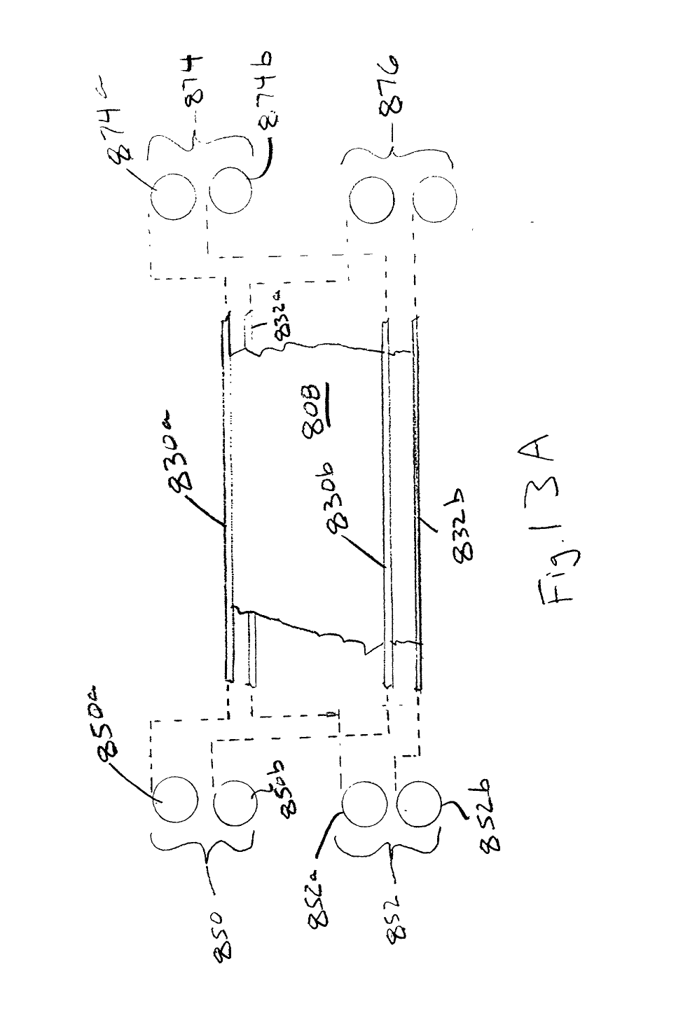

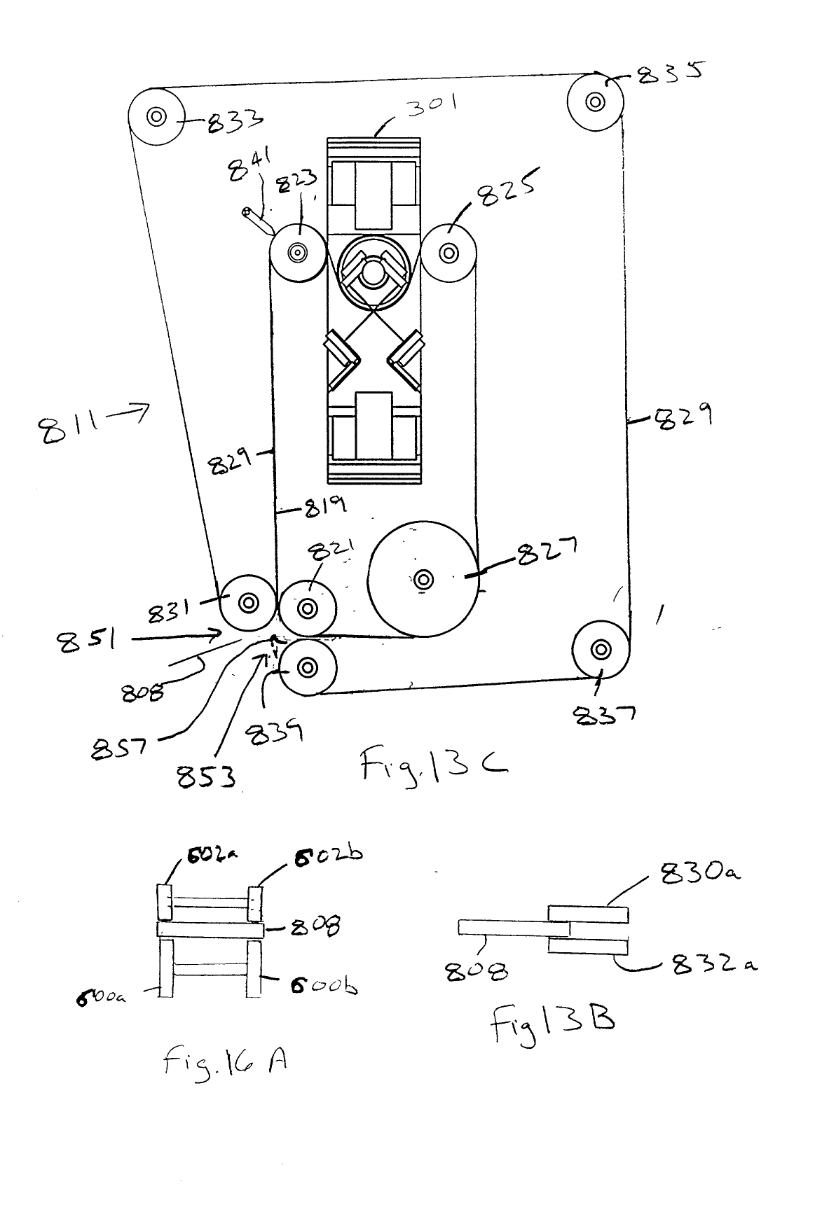

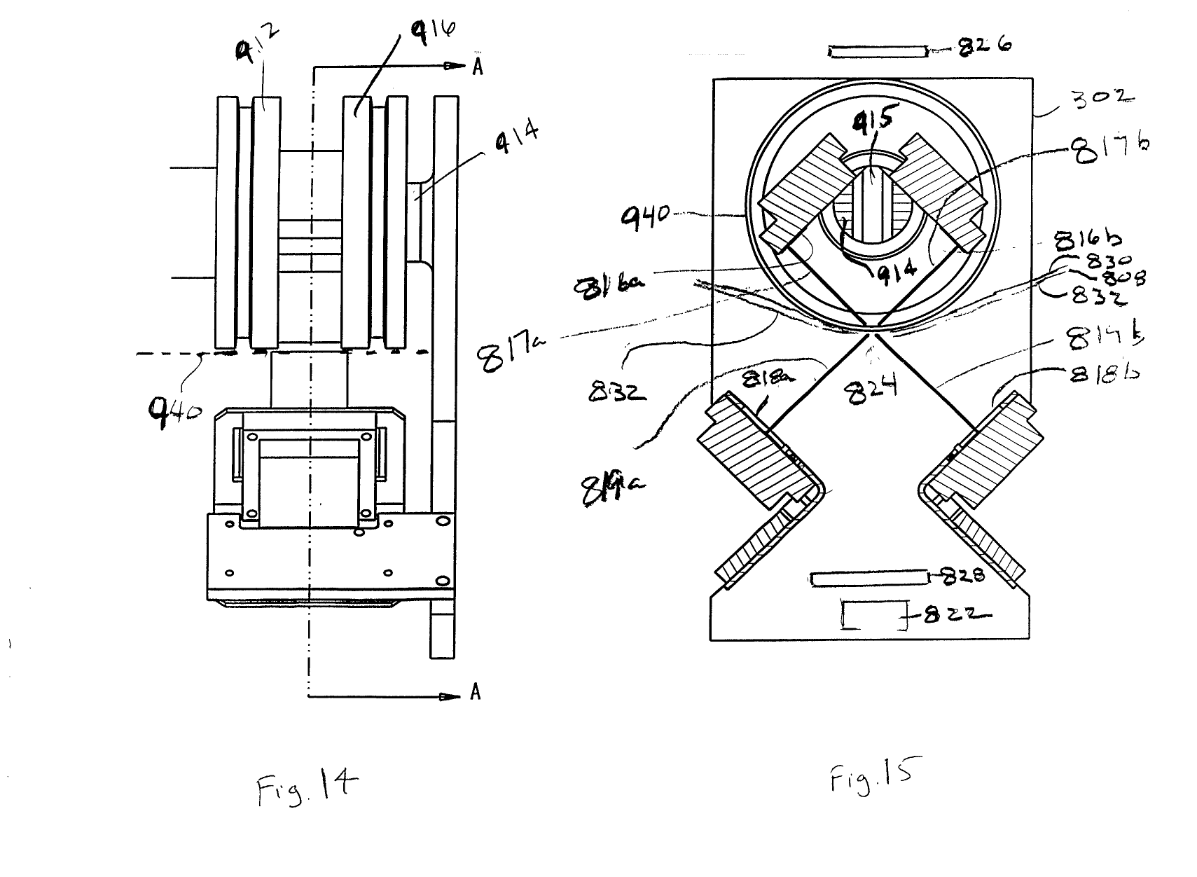

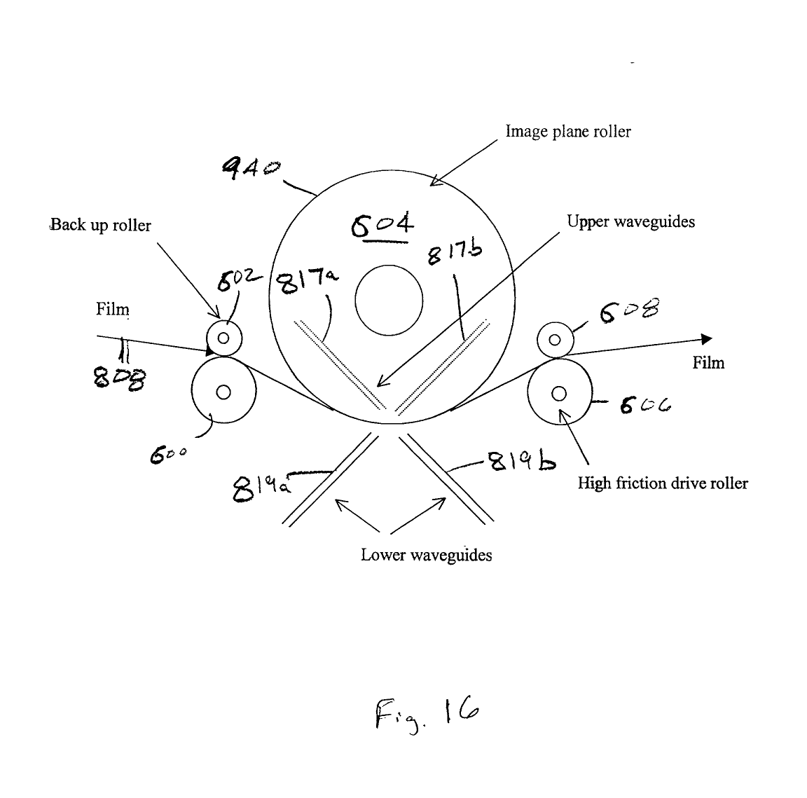

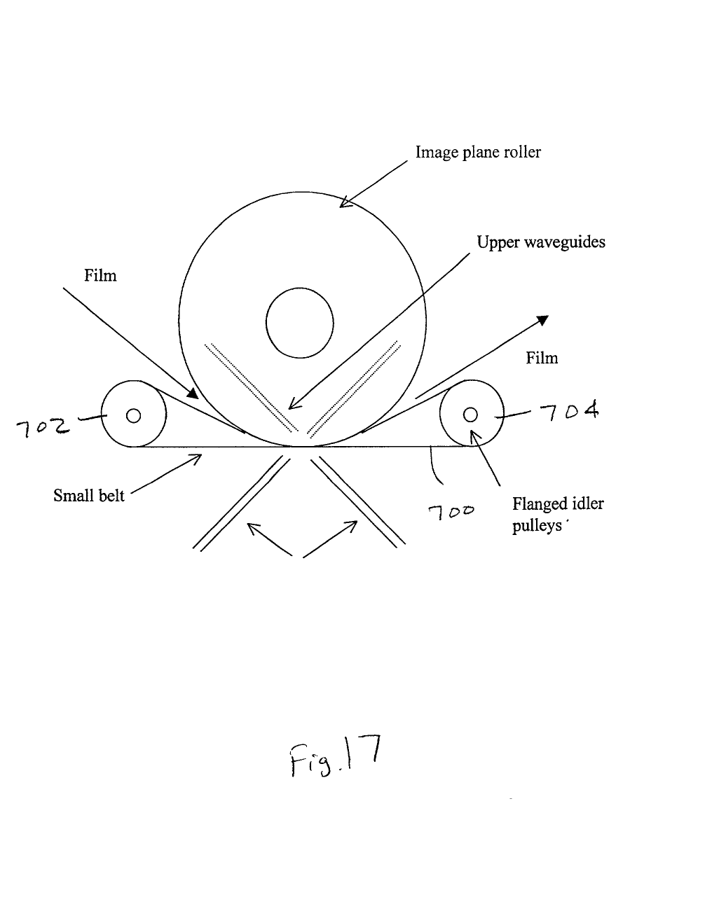

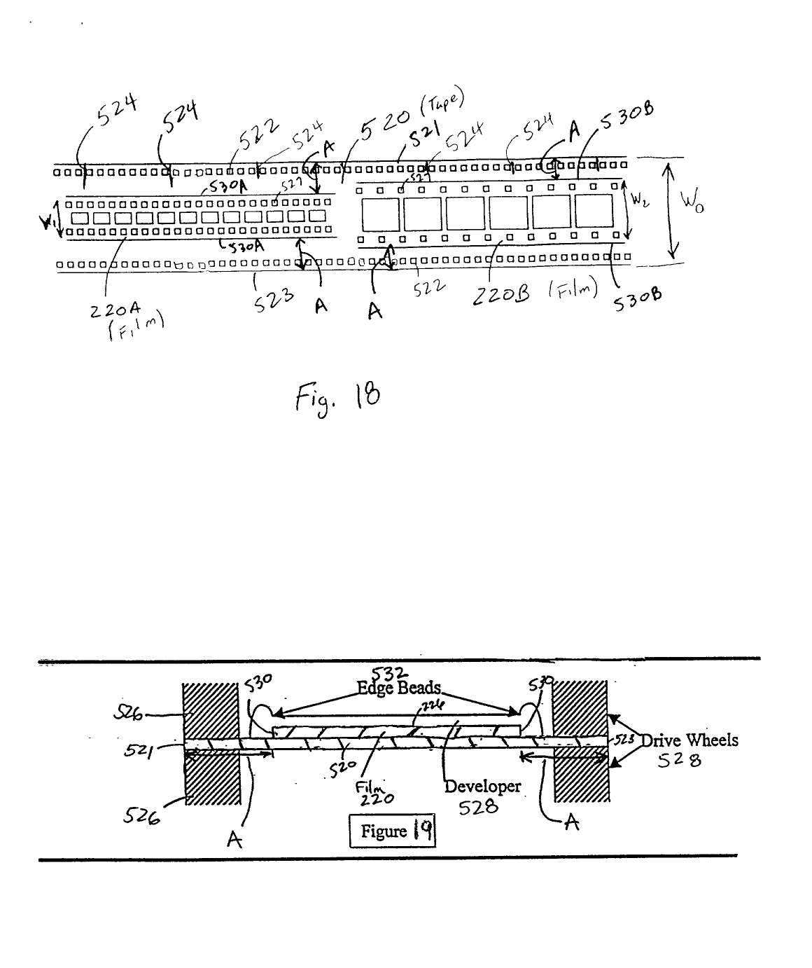

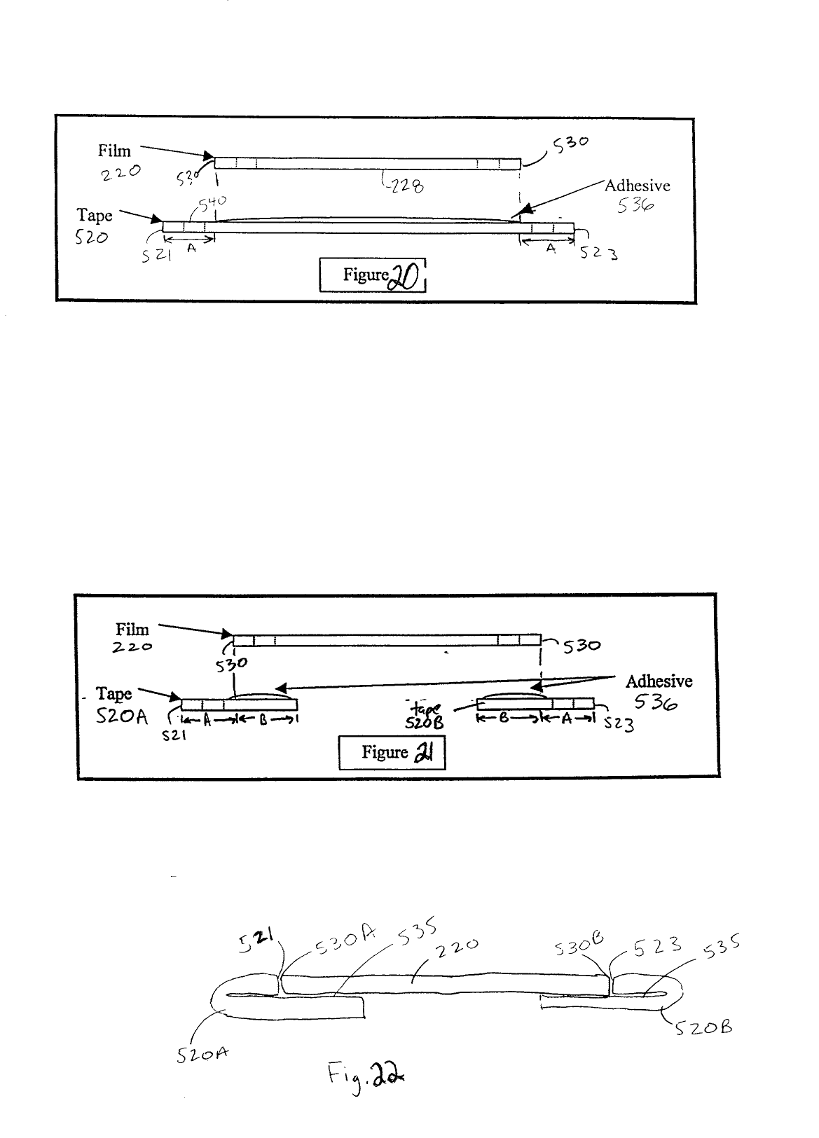

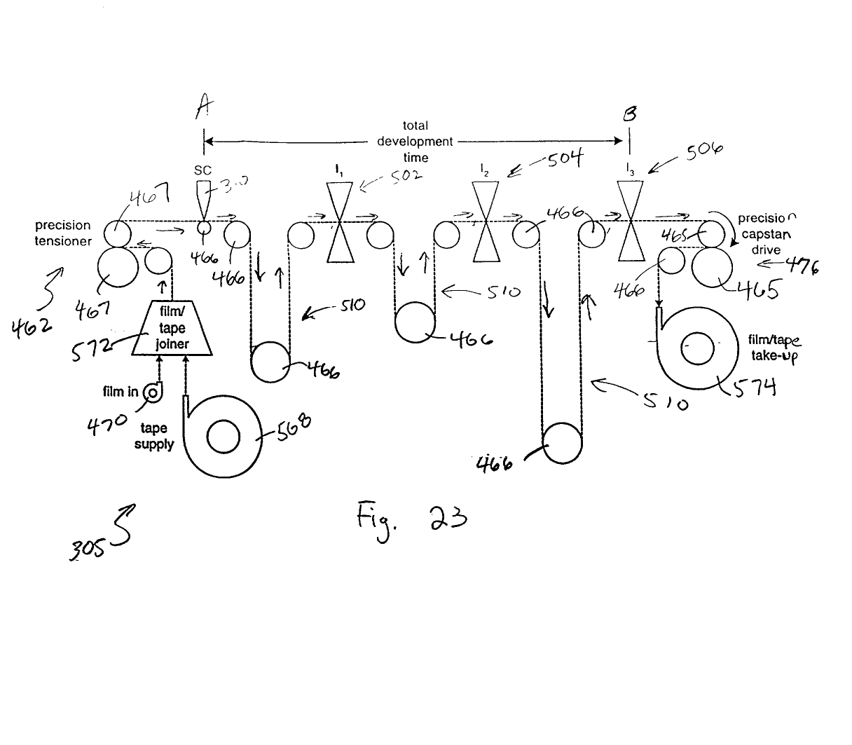

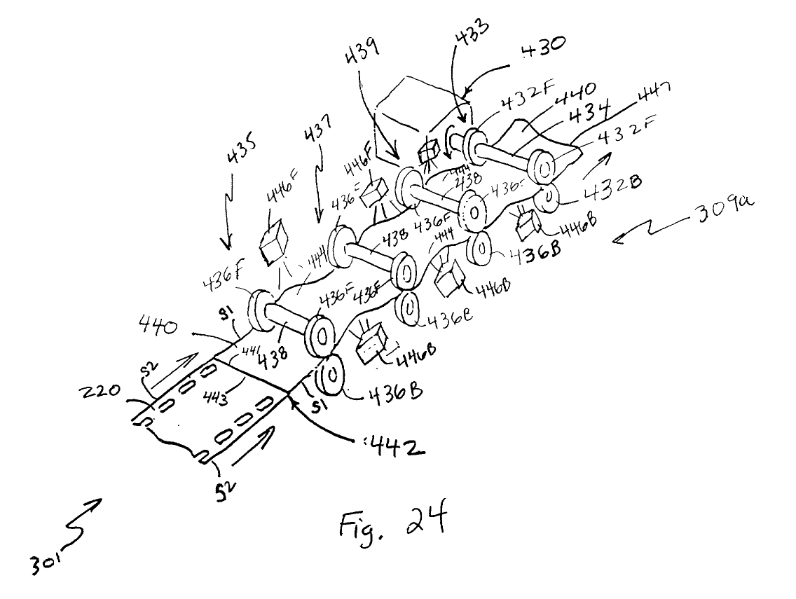

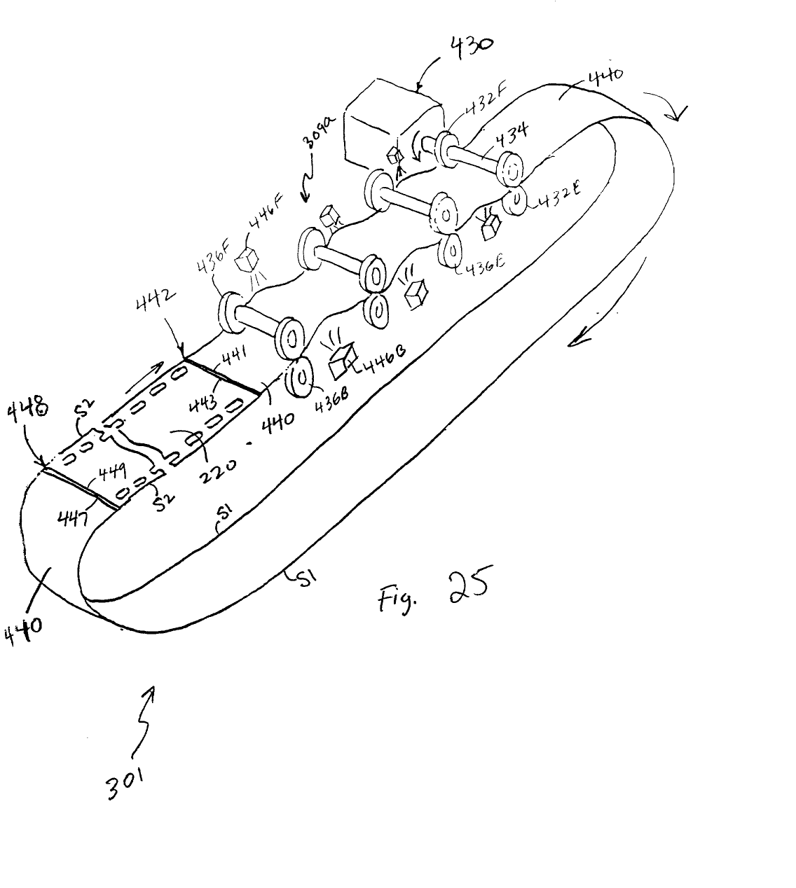

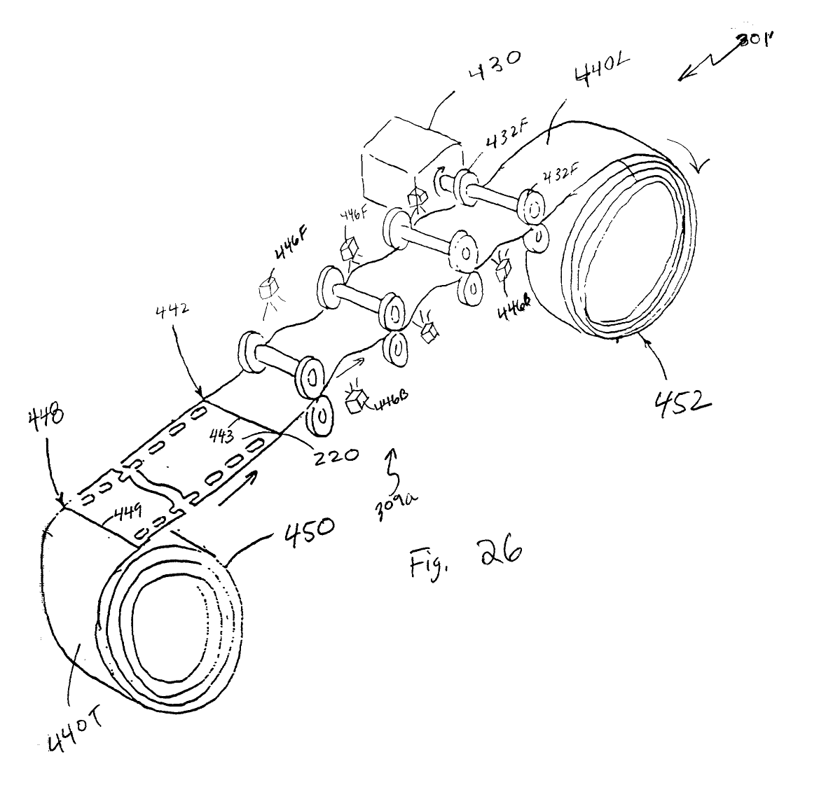

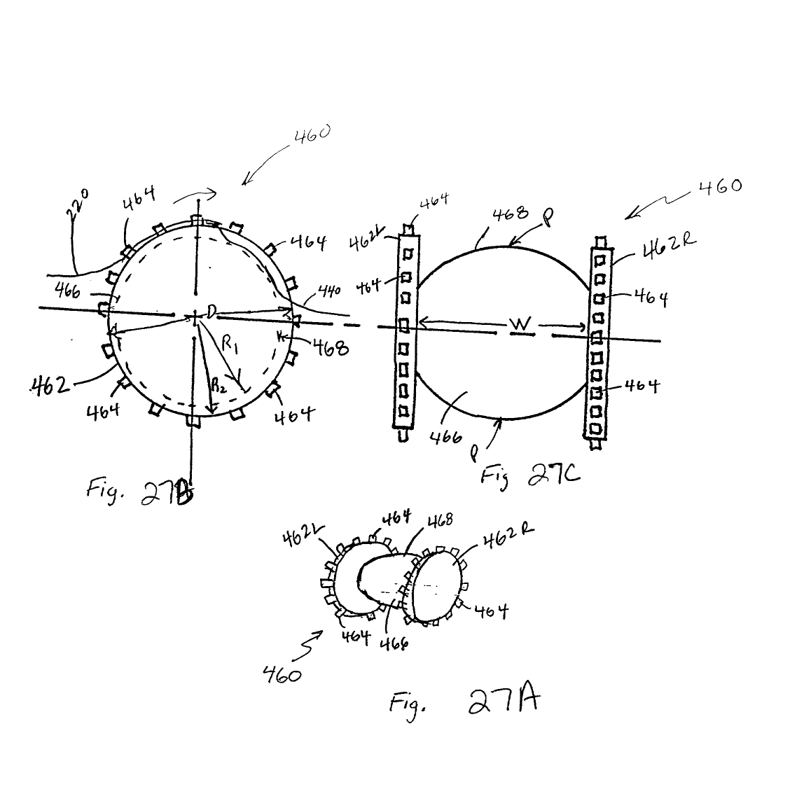

FIG. 1 shows one embodiment of an improved digital film processing system 100. The system operates by converting electromagnetic radiation from an image to an electronic (digital) representation of the image. The image being scanned is typically provided on a photographic film media 112 which is being developed using chemical developer. In many applications, the electromagnetic radiation used to convert the image into a digital representation is infrared light; however, visible light, microwave and other suitable types of electromagnetic radiation may also be used to produce the digitized image. For example, visible light may be utilized as disclosed in U.S. Provisional Patent Application No. 60/173,775, and in U.S. patent application Ser. No. ______ entitled Improved System and Method for Digital Film Development Using Visible Light (Attorney Docket No. ASF99324), the entire disclosures of which are hereby incorporated herein by reference. The scanning system 100 generally includes a number of optic sensors 102, which measure the intensity of electromagnetic energy passing through or reflected by the developing film 112. The source of electromagnetic energy is typically a light source 110 which illuminates the film 112 containing the scene image 104 and 108 to be scanned, which are forming on the film during the film development. Radiation from the source 110 may be diffused or directed by additional optics such as filters or waveguides (not shown) and/or one or more lenses 106 positioned between the sensor 102 and the film 112 in order to illuminate the images 104 and 108 more uniformly.

Source 110 is positioned on the side of the film 112 opposite the optic sensors 102. This placement results in sensors 102 detecting radiation emitted from source 110 as it passes through the images 104 and 108 on the film 112. Another radiation source 111 can be placed on the same side of the film 112 as the sensors 102. When source 111 is activated, sensors 102 detect radiation reflected by the images 104 and 108. This process of using two sources positioned on opposite sides of the film being scanned is referred to as duplex scanning and is described in more detail below in conjunction with FIG. 2.

The optic sensors 102 are generally geometrically positioned in arrays such that the electromagnetic energy striking each optical sensor 102 corresponds to a distinct location 114 in the image 104. Accordingly, each distinct location 114 in the scene image 104 corresponds to a distinct location, referred to as a picture element, or “pixel” for short, in a scanned image, or digital image file, which comprises a plurality of pixel data. The images 104 and 108 on film 112 can be sequentially moved, or scanned relative to the optical sensors 102. The optical sensors 102 are typically housed in a circuit package or unit 116 which is electrically connected, such as by cable 118, to supporting electronics for storage and digital image processing, shown together as computer 120. Computer 120 can then process the digital image data and display it on output device 105. Alternatively, computer 120 can be replaced with a microprocessor or controller and cable 118 replaced with an electrical connection.

Optical sensors 102 may be manufactured from different materials and by different processes to detect electromagnetic radiation in varying parts and bandwidths of the electromagnetic spectrum. For instance, the optical sensor 102 can comprise a photodetector that produces an electrical signal proportional to the intensity of electromagnetic energy striking the photodetector. Accordingly, the photodetector measures the intensity of electromagnetic radiation attenuated by the images 104 and 108 on film 112.

As previously described and as shown in FIG. 2, the embodiments of the present invention described herein use duplex film scanning which refers to using a front source 216 and a back source 218 to scan a developing film 220 with radiation 217 and 219 respectively. The applied radiation 217 and 219 results in reflected radiation 222 from the front 226 and reflected radiation 224 from the back 228 of the film 220, as well as transmitted radiation 230 and 240 that passes through all layers of the film 220. While the sources 216, 218 may emit a polychromatic light (i.e., multi-frequency light), in this embodiment of the digital film processing system 100 the sources 216, 218 preferably emit monochromatic light and most preferably infrared light. The resulting radiation 222, 224, 240, and 230 are referred to herein as front, back, front-through and back-through, respectively, and are further described below.

In FIG. 2, separate color layers are viewable within the film 220 during development of the red layer 242, green layer 244 and blue layer 246. More specifically, over a clear film base 232 are three layers 242, 244, 246 sensitive separately to red, green, and blue light, respectively. These layers are not physically the colors; rather, they are sensitive to these colors. In conventional color film development, the blue sensitive layer 246 would eventually develop a yellow dye, the green sensitive layer 244 a magenta dye, and the red sensitive layer 242 a cyan dye.

During chemical development of the film 220, layers 242, 244, and 246 are opalescent. Dark silver grains 234 developing in the top layer 246, (the blue source layer), are visible from the front 226 of the film by radiation 222, and slightly visible from the back 228 because of the bulk of the opalescent developer emulsion. Similarly, grains 236 in the bottom layer 242 (the red sensitive layer) are visible from the back 228 by reflected radiation 224, but are much less visible from the front 226. Grains 238 in the middle layer 244, the green sensitive layer, are only slightly visible to reflected radiation 222, 224 from the front 226 or the back 228. However, they are visible along with those in the other layers by transmitted radiation 230 and 240. By sensing radiation reflected from the front 226 and the back 228 as well as radiation transmitted through the developing film 220 from both the front 226 and back 228 of the film, each pixel in the film 220 yields four measured values, that may be mathematically solved for the three colors, red, green, and blue, closest to the original scene. For instance, a matrix transformation may be utilized as described in U.S. Pat. No. 5,519,510, the entire disclosure of which is hereby incorporated herein by reference.

The front signal records the radiation 222 reflected from the illumination sources 216 in front of the developing film 220. The set of front signals for an image is called the front channel (F). The front channel principally, but not entirely, records the attenuation in the radiation from the source 216 due to the silver metal particles 234 in the top-most layer 246, which is the blue recording layer. The front channel also records some attenuation in the radiation which is due to silver metal particles 236, 238 in the red and green layers 242, 244.

The back signal records the radiation 224 reflected from the illumination sources 218 in back of the developing film 220. The set of back signals for an image is called the back channel (B). The back channel principally, but not entirely, records the attenuation in the radiation from the source 218 due to the silver metal particles 236 in the bottom-most layer 242, which is the red recording layer. Additionally, there is some attenuation which is recorded by the back channel which is due to silver metal particles 234, 238 in the blue and green layers 246, 244.

The front-through signal records the radiation 230 that is transmitted through the developing film 220 from the illumination source 218 in back of the film 220. The set of front-through signals for an image is called the front-through channel (T). Likewise, the back-through signal records the radiation 240 that is transmitted through the developing film 220 from the source 216 in front of the film 220. The set of back-through signals for an image is called the back-through channel (T). The front source 216 can be energized at a first instance in time to record the front signal and back-through signal, and the back source 218 is energized at a separate instance in time to record the back signal and front-through signal. Both through channels record essentially the same image information since they both record attenuation of the radiation 230, 240 due to the silver metal particles 234, 236, 238 in all three red, green, and blue recording layers 242, 244, 246 of the film 220. Accordingly, one of the through channel signals can be disregarded.

Several image processing steps can then be used to convert the illumination source radiation information for each channel (B, F, and T) to the red, green, blue values for each spot on the film 220. These steps are conducted because the silver metal particles 234, 236, 238 that form during the development process are not spectrally unique in each of the film layers 242, 244, 246. These image processing steps are not performed when conventional scanners are used to scan film after it has been developed, because the dyes which are formed with conventional chemical color development of film make each film layer spectrally unique and also the silver metal particles 234, 236, 238 prohibit conventional scanning. However, just as with conventional scanners, once initial red, green, and blue values are derived for each image, further processing of the red, green, and blue values is usually done to enhance, manipulate, display, and/or print the image. Various image processing steps which may be utilized with the systems discussed herein are disclosed in U.S. patent application Ser. No. 08/999,421, and in U.S. Pat. No. 5,266,805, the entire disclosures of which are hereby incorporated herein by reference.

The exemplary embodiment of the digital film development system shown in FIGS. 1 and 2 can produce multiple digital image files for the same frame image at different film development times, each image file having back, front, and through values which are created using the duplex scanning method described above. It is desirable to create multiple duplex-scanned image files for the same frame at separate development times so that features of the frame image which appear at various development times can be recorded. During the film development process, the highlight areas of the image (i.e., areas of the film which were exposed to the greatest intensity of light) will develop before those areas of the film which were exposed to a lower intensity of light (such as areas of the film corresponding to shadows in the original scene). Thus, a longer development time will allow shadows and other areas of the film which were exposed to a low intensity of light to be more fully developed, thereby providing more detail in these areas. However, a longer development time will also reduce details and other features of the highlight areas of the image. In conventional film development, one development time must be selected and this development time is typically chosen as a compromise between highlight details, shadow details and other features of the image which are dependent on the duration of development. Scanning this developed film image using a conventional film scanner will not revive any of these details which are development-time dependent. However, in the digital film development process of FIGS. 1 and 2, such a compromise need not be made, as digital image files for the same image can be created at multiple development times while the film develops, and these multiple images can be combined to produce an enhanced image.

To carry out such multiple duplex scannings for an image, and as shown in FIG. 3, multiple separable scanning modules 302, 304, 306, and 308 can be utilized to produce the multiple digital image files of the same image, according to one aspect of the invention. Each module 302, 304, 306, and 308 in the digital processing system 300 includes a front source 216, a back source 218, a front sensor 116F, and a back sensor 116B, which operate as described above with respect to FIGS. 1 and 2. In particular, with reference to FIGS. 2 and 3, the front sensor 116F detects reflected radiation 222 (generated by front source 216), and also transmitted radiation 230 (generated by the back source 218). Likewise, the back sensor 116B detects the reflected radiation 224 (generated by back source 218), and the transmitted radiation 240 (generated by the front source 216).

Referring now solely to FIG. 3, the exemplary modules 302, 304, 306, and 308 are serially connected to form the system 300. This exemplary digital film processing system 300 has a pipeline configuration. In particular, each module 302, 304, 306, and 308 has a mounting member or panel 319, to which the various components of the module are secured. Each panel 319 has a film input side 320 and a film output side 322. In addition, each module 302, 304, 306, and 308 also has a film transport or guide assembly 333 having a film input opening 330 to receive the film, and a film output opening 332 to allow the film to exit. For example, each transport assembly 333 could define a slot within which an edge of the film is threaded. Thus, the edges of the film could be carried between two slotted rails or edge guides. The film input opening 330 of the first module 302 receives the film after developer has been applied by a suitable developer dispenser 310. The film output opening 332 of the first module 302 connects with the film input opening 330 of the second module 304, and the film output opening 332 of the second module connects with the film input opening 330 of the third module 306. Likewise, the film output opening 332 of the third module 306 connects with the film input opening 330 of the fourth module 308. Thus, the film travels in the direction 324 from the first module 302, to the second module 304, to the third module 306, to the fourth module 308. Finally, the film 220 exits from the system 300 via the film output opening 332 of the fourth module 308.

The film 220 is transported as a continuous strip through the film transport assemblies 333 of the modules 302, 304, 306, and 308 by suitable film transportation actuators, conveyors, and the like, exemplary embodiments of which are described in more detail below. Because of the time lag between transportation of an image on the film 220 between the modules 302, 304, 306, and 308, each module scans and records a digital image file of a given image at a different development time during the development of the film 220

For example, each image or frame on the film 220, such as frame F which resides between the points 312 and 314, could have developer applied thereto, such as by dispenser 310. The transportation actuator would then move the frame F through the film transport assembly 333 of the first module 302, where a first digital image file is created, using two reflectance signals (a back reflectance signal and a front reflectance signal) and one transmission signal (a back-through signal or a front-through signal) as described above with respect to the description of duplex scanning. The frame F would then be transported to module 304 where a second image file is created of the same frame, again using duplex scanning with two reflectance signals and one transmission signal. However, because of the predefined time lag in transporting the frame F from the first module 302 to the second module 304, the frame F would be scanned by the second module 304 at a later point in the development of the image on the frame F. Thus, some features of the image which might be appearing within the frame F during the development of the film 220 might be captured in the first data image file, but not in the second data image file, and vice versa.

The additional modules 306 and 308 can be connected into the system 300 to provide additional image data files for the frame F at additional development times of the frame. For example, after the second image data file is created for the frame F by the second module 304, a third image data file could be created for the frame F at a later development time by the third module 306 which would obtain two reflectance signals and one transmission signal. Similarly, a fourth image data file could be created by the fourth module 308 at the longest development time, also by obtaining two reflectance signals and one transmission signal. In this manner, four digital representations of the same frame image may be obtained at different development times, such as at 25%, 50%, 75%, and 100% of the total development time, for example. These four digital representations may then be combined with one another (i.e., stitched together) to form a composite digital representation of the image. This digital representation may be viewed on a video monitor associated with a computer, or printed on a printer connected to computer (such as a laser printer or an ink jet printer), saved to a file, and/or communicated over a communication link, for instance.

As shown in FIG. 3, and according to one aspect of the present invention, each module 302, 304, 306, and 308 is separable from the system 300. Accordingly, although the system 300 is shown with four modules, the system can be easily provided with fewer than four or more than four modules as desired by the user. For instance, if the user desired a system with only three modules to save cost, the module 308 could be disconnected from the module 306 and removed from the system.

A housing for the entire system 300 can be provided, and each module 302, 304, 306, and 308 can be moved into and out of the system housing as desired by installing the mounting panel 319 for the module into the housing, or removing the mounting panel 319 from the housing. Because the various components (e.g., 216, 218, 116F, 116B, 333) of each module are secured, directly or indirectly, to the mounting panel 319, the entire module can be handled by manipulating the panel 319; the individual components of the module do not need to be handled separately, thereby making modifications to the overall system 300 relatively simple. As an alternative to the mounting panel 319, other mounting members or housings could be utilized to secure the various components of a single module for ease of handling.

One modification that can be made is the removal or addition of one or more modules. For example, by removing the module 308 from the system 300, only three digital image files will be created by the system, one by the module 302, one by the module 304, and one by the module 306. Accordingly, the resulting system 300 is made less expensive and has a reduced size, by the elimination of module 308.

If module 308 is removed, it may be desirable to adjust the film development times during which the remaining modules 302, 304, and 306 take image data files, such that these modules take their image data files at optimal times during the film development process. Several methods can be utilized for adjusting the film development times during which the digital image files, such as by adjusting the film transportation buffering system, the film speed, and/or the configuration or spacing of the remaining modules 302, 304, and 306.

As another example of the flexibility of the exemplary system 300, if one of the modules 302, 304, 306, or 308 were to need repair, the broken module could easily be removed from the system 300 by removing its mounting panel 319. It is preferred that all modules have substantially identical components and a substantially identical configuration of such components, such that the replacement of the broken module does not hinder the operation of the system. For example, if module 306 were to need repair, it could be removed, and replaced with a working module that is substantially identical. Thus, even though the module 306 is broken, the system 300 could then continue running even after the module 306 was removed and was being repaired. Accordingly, processing of film 220 could continue while the module 306 is being serviced remotely from the system 300. Thus, the system 300 would not be rendered useless by the malfunction of one or more of the modules 302, 304, 306, or 308.

Accordingly, because of the removability and standard design of the modules 302, 304, 306, and 308, the system 300 remains flexible, and easy to upgrade and service, according to one aspect of the invention.

FIGS. 4 and 5 illustrate a more detailed exemplary embodiment of the modular digital film development system of FIG. 3. In this embodiment, in addition to the radiation sources 216 and 218, the sensor circuit boards 116F and 116B, the mounting panels 319, and the film transport/guidance assemblies 333, each of the four modules 302, 304, 306, and 308 also include a pair of optics units 106B and 106F. As discussed above, the optics units 106B and 106F are used to focus the radiation from the sources 216 and 218 onto the respective sensors 116B and 116F.

As also shown in FIGS. 4 and 5, a film loading unit 380 can be provided to input the film into the system 300, and to cut the film and/or a leader strip if desired. Film loading and cutting actuators can be provided to assist in the cutting and loading of the film. These actuators can include motors, solenoids, and other appropriate devices. Also shown in FIG. 4 is a slot coater module 382 which includes a slot coater head 310 to apply developer to the film and a slot coater wiping roll 384 to clean the film prior to the developer application. The components of the slot coater module 382 are also secured to a panel 319 for ease of removal and handling. Like the scanning modules 302, 304, 306, and 308, the slot coater module 382 also includes a film transport assembly 333 for transporting the film.

In the exemplary system 300 shown in FIGS. 4 and 5, the modules 382, 302, 304, 306, and 308 are secured within the system 300 by connecting the mounting panel 319 to a frame 301, which preferably has apertures to receive pins or other connection mechanisms for securing the mounting panel to the frame. The entire system 300 can reside within a housing or cabinet 385 which provides a dark environment for the film development, and which also allows the system to be contained and moved as a unit, if desired.

In accordance with another aspect of the invention, as also shown in FIGS. 4 and 5, it is preferred that film buffer assemblies 329 are located between the film transport assemblies 323 of each module 382, 302, 304, 306, and 308, to compensate for tension and/or slack in the film between the modules, and to allow the film to develop further between the modules. As shown in FIGS. 4 and 5, these buffer assemblies 329 can act as additional film guides or tracks which are in line with the film transport assemblies 333 of the modules 302, 304, 306, and 308, and are placed in between the tracks of the assemblies 333. The buffer assemblies 329 can include a hinged trap door or platform over which the film can move. In particular, as shown in exemplary embodiment of FIG. 6, the film buffer assembly 329 can include a buffer housing or 402 support to which the various components of the assembly can be secured. The housing 402 includes a trap door opening 404 through which the film may spill. To cover this opening, a movable film platform or trap door 406 is provided, which rotatably attaches to the housing 402 via a hinge or shaft 408 such that it can move between the closed position in which the film bridge 406 covers the opening 404 to an open position (shown in FIG. 7) in which the film bridge extends downwardly through the opening 404. When in the closed position, as shown in FIG. 6, the film travels between the trap door 406 and an upper guide 412 which covers the door 406 and is secured to the top of the housing 402.

To rotate the trap door 406 about the axis 408 between the open and closed positions, a motor 414 or other actuator is provided, which is a stepper motor in the exemplary embodiment. The motor 414 is mounted to a motor mount plate 403 which is secured to the buffer housing 402 via screws. Pulleys 416 and 418 and pulley belt 417 are provided to link the motor 414 to the shaft 408. The pulley 418 is mounted on the shaft 408 along with a bearing 419. Likewise, the pulley 416 is mounted to the motor 414. Rotation of the motor 414 causes movement of the pulley belt 417 which engages both pulleys 416 and 418, causing movement of the shaft 408 and rotation of the trap door 406 between the open and closed positions. Other alternatives are possible for providing a film buffer opening between the modules. For example, the trap door 406 could slide between an open position and a closed position to reveal the opening.

Connected to the door 406, and substantially perpendicular thereto, are a pair of film guide arms 410, as shown in the exemplary embodiment of FIGS. 6 and 7. When the door 406 is in the closed position of FIG. 6 and the film travels between the door 406 and the upper guide 412, the guide arms 410 extend upwardly. However, when the door 406 moves downwardly at the selected time by force of the motor 414, the guide arms 410 move downwardly until the bearings 411 at the end of the arms 410 are adjacent the edge 422 of the housing 402. Accordingly, as shown in FIG. 7, the film travels between the bearings 411 and the edge 422 and is free to travel downwardly through the opening 404 because the door 406 will no longer cover the opening. FIG. 8a shows the closed position of these components, with the film 220 being contained between the door 406 and the upper guide 412. FIG. 8b shows the open position, where the door 406 no longer covers the opening 404 and the film 220 is free to travel downwardly through the opening 404. However, to keep the developing film 220 from attempting to join together and potentially interfering with the film development, the film travels downwardly between the bearings 411 of the guide arms 410 and the edge 422 of the opening 404. Accordingly, the film is allowed to slack through the opening 404, but is controlled by the guide arms 410. The slacking portion of the film 220s is also controlled and contained between the film channel arms 400L and 400R, shown in FIGS. 5-7.

Thus, when the door 406 is in the closed position, the film can be threaded through all sections of the transport assembly 333. However, with reference to FIGS. 4 and 5, the doors in the buffer assemblies 329 can be moved from a closed position to an open position to allow the film to spill downwardly toward the bottom of the given module 382, 302, 304, 306, or 308. Accordingly, if the film driving actuators of the various modules 382, 302, 304, 306, and 308 have slight differences in speed or movement of the film 220, rather than resulting in jamming or buckling of the film in the tracks assemblies, the film 220 can move downwardly through the opening where the trap door once was located and into the film spill channel 400, which is defined by a pair of film guide members 400L and 400R. Thus, the system 300 will not malfunction and the film development process conducted can continue without interruption, thereby reducing maintenance downtime and related expense.

FIGS. 9 and 10 show two exemplary embodiments of film guidance/transport assemblies 333 which can be used in any of the modules 382, 302, 304, 306, and 308 of the modular film development systems of FIGS. 3, 4 and 5. Included in each assembly 333 is an upper transport housing 340 which secures to a lower film guide 327. The developing film is transported and guided between the transport housing 340 and the lower film guide 327, such as by moving the film through a slot formed between the housing 340 and lower film guide 327.

The lower film guide 327 includes an arcuate film scanning bridge 325 with a center scanning opening 370. The film travels over the bridge 325 but beneath the transport housing 340 during scanning. Radiation is directed through the opening 370 to sequentially scan rows of the developing film. Accordingly, by guiding the film over the arcuate bridge 325, the longitudinal edge of the film is formed into the shape of an arc in the portion where radiation is applied. The arcuate bridge 325 can be in the shape of an arc which is circular in nature and which has a radius of from about 1.00 to about 2.00 inches. However, it is contemplated that other arcuate shapes having constant or variable radius could be utilized. Because the film is flexible, as photographic film typically is, it takes on an arcuate shape as it moves over the arcuate scanning bridge 325. By positioning the film in a curved or arcuate shape, it is possible to accurately control the location of the top surface of the film, which is important in digital film development to provide good scanning results, as the scanning equipment (e.g., a source and/or a sensor) is precisely focused to a particular depth where the film is expected to reside. Tensioning the film over an arcuate or curved surface allows little possibility that the film will wrinkle, bend, or buckle or take on uncontrolled shapes which may affect the radiation which is sensed by the sensor, and thereby cause inaccurate digital image data. In particular, tensioning the film over an arcuate surface reduces the risk that the film will rise off that surface, or otherwise take on an uncontrolled shaped, and consequently focus the scanning equipment off of the image on the film. In contrast, positioning the film on a flat surface is less preferred, as the film may more easily rise off of such a surface.

FIG. 11 illustrates an exemplary arcuate configuration of the film 220 as it is scanned by the sources 216 and 218 and the sensors 116F and 116B. Between the points A and B, the film 220 takes on a generally arcuate shape. The tension on the film 220 is provided by the wheels 360A and 360B, or other transport elements such as sprockets or rollers, which engage the film and drive it over the arcuate bridge 325. Radiation is applied to the film from the sources 216 and 218 through the scanning opening 370. To provide the tension, wheels 360B may be driven slightly faster than wheels 360A, as described in further detail below. Other configurations for placing the film 220 in an arcuate shape during scanning can also be utilized. For example, FIG. 12 shows the use of an arcuate member 323, over which the film 220 is driven.

Returning again to the exemplary embodiments of FIGS. 9 and 10, the film transport assemblies 333 can include driving mechanisms and linkages to force the film over the arcuate bridge 325. More specifically, a motor 350, or other suitable drive mechanism or actuator, is provided to supply the driving force for moving the film between the transport housing 340 and the lower film guide 327. The motor 350 can comprise any suitable motor for supplying the driving force, such as an AC or a DC motor for example. The motor 350 can comprise a stepping motor, which is sometimes referred to a stepper motor. Such a motor converts electrical pulses into discrete mechanical movements of a shaft or spindle. The speed that the shaft rotates is directly related to the frequency of the input pulses, and the length of the rotation is directly related to the number of input pulses applied. One advantage of using a stepper motor is its ability to be accurately controlled without the need for closed loop control and the expensive sensing and feedback devices associated therewith. Because each applied pulse causes a known incremental step in rotation, the position of the motor can be known simply by keeping track of the number of input step pulses applied to the motor. A cable 351 can be provided to supply the electrical control signals to the motor 350. Such control signals can be controlled by a programmed microprocessor or controller which can be utilized to control the film movement through the assembly 333, the scanning of the film by the sources, and the creation of pixel data by the sensors. For example, the computer 120 of FIG. 1 could be utilized for controlling these operations, and for controlling the application of control signals through the cable 351 to the motor 350.

To transmit the rotational motion of the motor 350 to the film driving wheels 360, any suitable connection or linkage members can be provided. In the exemplary embodiments of FIGS. 9 and 10, the motor 350 drives a shaft 352 which has a linking gear 354 connected thereto. The linking gear 354 engages a pair of gears 358 and 356, which are connected to shafts 362 and 364 respectively. Connected to each of the shafts 362 and 364 are a pair of film driving wheels 360. Spacers 361 and other suitable connection members can be utilized for placement of the wheels 360 along the shafts 362 and 364. The wheels 360 could comprise friction wheels or pinch rollers, in which case the bottom 366 of each wheel 360 contacts the top surface of the film near the edge of the film and clamps the film between the wheel 360 and a surface 368 to thereby force the film between the lower film guide 327 and the transport housing 340 of the film guide assemblies 333 of FIGS. 9 and 10. In the embodiment of FIG. 9, the surface 368 resides on four rollers 367. These rollers 367 can be splayed toward the side edges 369 of the lower film guide 327. By splaying the rollers 367, the film can be tensioned in the film's transverse direction 381 during scanning to thereby further resist the wrinkling or other uncontrolled movement of the film and provide optimum scanning results.

As is also shown in the exemplary embodiments of FIGS. 9 and 10, it is preferred that the film is placed in tension in the longitudinal direction 383 as it is scanned by the sources. In particular, the gears 356 and 358 are sized such that the shaft 362 rotates slightly slower than the shaft 364. Preferably, the speeds of the shafts 362 and 364 differ by at least 1.5 percent, and more preferably from about 5 to about 12 percent. This causes tension across the film between the shaft 362 and the shaft 364, as the film row over the opening 370 is being scanned by the sources. As noted above, and according to another aspect of the invention, tensioning the film can be utilized to ensure that the film remains precisely positioned during the scanning process. Buckling or wrinkling of the film during scanning can result in inaccurate image data. The tension provided on the film is preferably from about 0.5 ounces to about 10 pounds, more preferably from about 4 ounces to about 14 ounces, and even more preferably from about 8 to about 12 ounces, although any tension which does not tear the film can be utilized. The differing speeds can be accomplished by providing gears 356 and 358 with differing numbers of teeth. For example, gear 356 could have 168 teeth, while gear 358 could have 180 teeth, providing a gear ratio of 168 to 180.

To prevent the film from tearing due to the difference in speeds of the rotating shafts 362 and 364, a slip clutch 371 or other friction device can be used to disengage the gear 358 from the link gear 354. In particular, the slip clutch 371 will disengage the gear 358 from the link gear 354 when the torque on the shaft 362 reaches a predetermined level due to the film being pulled by the shaft 364. The slip clutch 371 can comprise any suitable slip mechanism that disengages a gear and/or reduces torque upon application of a predefined overload torque level. Suitable slip clutches may include spring members, friction devices, sliding plates, and/or ball elements, for example, as known in the art. Thus, the slip clutch 371 can cause the shaft 362 to slip relative to the shaft 352 when subjected to an overload torque. The amount of overload torque which will cause the clutch 371 to slip will be a function of the film tension and the drive wheel diameter. As an alternative to a slip clutch 371 and driving gears 356 and 358, other mechanisms for maintaining tension on the film without tearing the film could be utilized.

In addition to the center opening 370, a reference area 390 can be provided. Medium delivered through this area 390 can be scanned to provide a reference or target against which the images scanned from the scanning row 370 can be corrected, calibrated, normalized, or otherwise processed.

While FIGS. 9 and 10 illustrate exemplary film transport/guidance systems and components, other systems and components can be used to drive and transport the film. For example, the film can be driven by a single shaft rather than a pair of shafts, and tension can be provided by a resistance to the forward film movement. Moreover, the wheels 360 could comprises sprockets which engage openings on the film edges. As another alternative, rather than engaging the film directly, the wheels 360 could engage a conveyor tape or belt which in turn is connected to or supports the film. Furthermore, a roller or capstan can be used to drive the film. Other suitable linkages may also be utilized, such as belts for example, in transmitting the power from the driving mechanism to the film. Moreover, in addition to the transportation elements disclosed in FIGS. 9 and 10, other rollers, wheels, spindles, spools, and related devices can be utilized in the systems of FIGS. 3, 4, and 5 to complete the transportation of the film through the system.

Operation of the exemplary film development system will now be described with reference now to FIGS. 4-10. In particular, the opening and closing of the trap door 406 using the motor 414 may be conducted manually as desired, or automatically upon sensing a particular condition, such as upon sensing film buckling or jamming for example, or upon sensing that the film has reached a particular location. For example, once the film has reached a location in the first scanning module 302, the trap door 406 of the film buffer assembly 329 between the slot coater module 382 and the scanning module 302 could open via a control signal from the controller. (The position of the film can be sensed by any suitable sensor, such as an infrared sensor.) Then, the motor 350 in the slot coater module 382 could be activated to continue to drive the film, while the motor 350 in the first scanning module 302 could be stopped. Accordingly, the film will spill downwardly into the film spill channel 400 between the modules 382 and 302. Once a predetermined amount of film has been spilled out, or the motor of module 382 has been driven for a period of time, the motor 350 of scanning module 302 can once again become active and the film can be driven further toward the second scanning module 304. A similar film spill process can then occur when the film reaches a predetermined position in the second scanning module 304, the third scanning module 306, and the fourth scanning module 308. Accordingly, slack zones 220S will exist in the film between the various modules 382, 302, 304, 306, and 308, as shown in FIG. 5. These zones 220S alleviate film buckling or jamming which may occur due to differences in the film driving speeds of the various modules. Moreover, these slack zones give the film additional time to develop between modules, without requiring an increase in size of the system 300 or a decrease in speed of the digital film development process. The amount of additional development time can be adjusted by changing the length of film that is allowed to spill in to the slack zone.

As noted above, in this exemplary embodiment, the portion of the film being scanned is tensioned in both the longitudinal and transverse directions as it travels over the scanning opening 370. Radiation is applied to the film through the opening 370 using the sources 216 and 218. For each pixel, reflected radiation is sensed from the back and front of the film using sensors 116F and 116B. Radiation transmitted through the film is also sensed. (The sources 216 and 218 can be fired at separate times to allow the sensors 116F and 116B to distinguish between reflected and transmitted radiation.) Accordingly, back, front, and through data is obtained for each pixel of the image, and this data can be used to derive R, G, and B signals for the image. For each image, multiple sets of back, front, and through data are obtained at differing film development times using the various scanning modules 302, 304, 306, and 308. These multiple data sets for each image can be combined to form an enhanced image which includes features from various film development times.

As an alternative to actively opening the trap doors 406, and as shown in the embodiment of FIG. 11, a tab 334, made of a flexible and resilient material, such as a plastic material, could be provided which engages a recess or surface 336 on the adjacent piece of edge guide 328. Pressure from buckling or jamming film 220 could disengage the tab 334 from the recess 336 to cause the door 406 to open and the film to spill downwardly through the opening. Alternatively, rather than utilizing a lock mechanism 334 which gives way after a particular amount of film pressure, the trap door portions 406 be provided without such a mechanism, and can loosely abut a subsequent section of the film guides 328. Because of the loose contact, the trap door 406 is kept close. However, pressure from film buckling will overcome the abutting force, the trap door 406 will proceed to give way, and the film 220 will begin to spill out through the opening 404. Again, film jamming and machine malfunction are avoided, and speed deviations between various film driving devices can be tolerated.

As another alternative, the trap door portions 406 can simply comprise missing or removable film guide sections rather than actual hinged doors. Such missing sections provide slack zones in the film travel path, so as to provide pressure relief or buckling relief for the film as it travels through the film guides 326, and to accommodate any deviation between the film transporting mechanisms used to move the film through the system.

As noted above, in addition to providing film pressure relief, allowing the film to spill downwardly via a trap door section 406 also provides a longer film travel path between the modules. As can be understood, controlling the development time between scans can be accomplished by varying the film length path between modules and/or the film speed as it travels between modules. Thus, by allowing the film to spill downwardly between modules in accordance with this aspect, the film travel path can be increased between the scanning modules. However, the overall horizontal length of the system 300 need not be increased to increase this film travel path length, as the trap door sections 406 allow the film travel path length to be increased in the vertical direction. Accordingly, the system 300 can remain relatively compact, while still allowing for flexibility in controlling the film development intervals which takes place between the various scans taken by the modules 302, 304, 306, and 308.

Referring now to FIG. 13, another exemplary digital film processing system 300 for obtaining multiple image files for the same image at separate development times is shown schematically. The processing system 300 includes a plurality of processing units 302, 304 and 306 through which a strip 808 of photographic film media is serially transported.

Transport of the film strip 808 through the processing units 302, 304 and 306 is accomplished through the agency of a belt assembly, generally identified by the drawing numeral 810, described in greater detail below. This belt assembly 810 initially transports the film strip 808 to a developer station 812 where a developer nozzle 814 deposits developer solution onto a central portion of the film strip 808 containing the images 104 (see FIG. 1). After the developer solution is applied, the film strip 808 is transported to the first of the plurality of processing units 302.

As shown more clearly in FIG. 15, the processing unit 302 scans the film strip 808 with electromagnetic radiation, such as infrared light, from front sources 816a, 816b and back sources 818a, 818b. A portion of the radiation emitted by front sources 812a and 812b will be reflected by the film strip 808 and sensed by sensor 820. Another portion of the radiation emitted by these sources 816a and 816b will be pass through the film strip 808 and be sensed by sensor 822. Similarly, a portion of the radiation emitted by back sources 818a and 818b will be reflected from the film strip and sensed by sensor 822, while another portion of that emitted radiation will pass through the film strip 808 and be sensed by sensor 820. Radiation from sources 816a and 816b are directed to the film strip 808 at location 824 by wave guides 817a and 817b respectively. Similarly, radiation from sources 818a and 818b are directed to the film strip 808 at location 824 by wave guides 819a and 819b. If desired, optical elements, as for example lenses or filters 826 and 828 may be used to focus and otherwise condition the radiation from the film strip 808 prior to being received by sensors 820 and 822 respectively. The combination of these radiation sources and sensors permits the creation of front channel, back channel and through channels (either front-through channel or back-through channel) image files for each image 104 on the film strip 808 in the manner generally described above in connection with FIG. 2. The radiation sources shown in the specifically illustrated embodiment, radiation sources 816a, 816b, 818a and 818b, are assemblies including infrared LEDs, a heat sink and fan assembly, all housed in a single unit. The processing units 302, 304 and 306 of the illustrated embodiment are each scanning/imaging stations or modules, are identical to each other in construction, and can be separable and removable. Accordingly, only processing unit 302 will be specifically described with respect to its components, it being understood that processing units 304 and 306 have similar components arranged in a similar configuration to operate in a similar manner at a later time in the development process than processing unit 302.

After completing the scanning process and the creation of image files at processing unit 302, the film strip 808 is transported to second processing unit 304 (FIG. 13), and thereafter to processing unit 306, where it is similarly scanned to create second and third sets of image files for each image on film strip 808. As suggested above, scanning at the processing units 304 and 306 may occur after the scanning at processing unit 302, and the timing of the transport of the film strip 808 to the various processing units 302, 304 and 306 may be controlled so that each of the processing units 302, 304 and 306 scans the film strip 808 at a different predetermined times after the film development process has been commenced by application of the developer solution. Accordingly, three processing units 302, 304 and 306 may be used to scan the film strip 308 at three different stages of development to produce optimal results in capturing the image. For example, processing unit 302 may be used to scan the film strip 808 at a time in the film development process when areas of the film exposed to the greatest intensity of light are optimally scanned, processing unit 306 may be used to scan the image at a time that the areas of the image having the lowest intensity of light, such as shadows, are optimally scanned, and processing unit 304 may be used to scan the same image at an intermediate time when those areas of the image having exposure to an intermediate intensity of light are optimally scanned. The image files created from scanning the image at these different development times are then combined by a suitable algorithm to produce a resultant image that avoids the necessary development time compromises, referenced above, of conventional film development.

FIG. 13c shows a schematic of an alternative embodiment that may be used to create multiple image files for images at different times after the development time is commenced by the application of a developing solution to the film strip 808. The embodiment of FIG. 13c includes a single processing unit 301, which processing unit 301 may be a scanner having a construction identical to that of the scanners 302, 304 and 306 discussed above in connection with FIG. 13. Like the embodiment of FIG. 13, the embodiment of FIG. 13c may be used to scan a film strip 808 at multiple different stages of development (i.e., multiple different predetermined times after application of a developer solution) and to combine the resulting image files from those multiple scans to produce optimal images from the film strip 808. The embodiment of FIG. 13c differs from the embodiment in FIG. 13 in that film strip 808 is recirculated through the system and the images on the film strip 808 are scanned at multiple different stages of development by the same scanner 301. In order to accomplish this functionality with a single scanner 301, a belt assembly 811 for recirculating the film strip 808 through the scanner 301 is used in FIG. 13c. The belt assembly 811 consists of an inner pair of belts 819 (only the outermost of the belts in the belt pair 819 being shown in FIG. 13c) that are movable about a pair of spaced rollers 821 (only one of the roller of the pair of which is shown in FIG. 13c), and correspondingly spaced pulley sets 823, 825 and (drive pulley) 827 (only one (the outermost) pulley in each pulley set being shown in FIG. 13c). An outer pair of belts 829 (again, only the outermost of the belts in the belt pair 829 being shown in FIG. 13c) is movable about rollers 831, 837, and 839, and about spaced pulley sets 833, 835, (drive pulley) 827, 825, and 823 (only one (the outermost) pulley in each pulley set being shown in FIG. 13c).

The film strip 808 is initially entered into the belt assembly 811 of FIG. 13c at an entrance/exit area generally designated by the numeral 851 where the film strip 808 is fed into the nip of two pairs of counter-rotating rollers 821 and 831. As the film strip 808 is fed between rollers 821 and 831, it is interposed between and compressingly engaged by opposing sides by belt pairs 819 and 829. The belt pairs 819 and 821 then transport the interposed and captured film strip 808 past a developer nozzle 841 which applies developer solution to the central portion of the film strip 808. The film strip 808 is thereafter transported (again between belt pairs 819 and 829, which belt pairs 819 and 829 contact the film strip 808 only on its lateral portions, without touching the central portion of the film strip 808 having the latent images and developer solution) through scanner 301 where the scanner 301 creates a first image file in the manner described above in connection with FIG. 13 as the film strip 808 is first passed through the scanner 301. The belt pairs 819 and 829 with the interposed film strip 808 then exit the scanner 301 where the belt pairs 819, 829 and film strip 808 are directed by idler pulley 825 to the drive pulley 827 and thereafter through rollers 821 and 839 back to the entrance/exit area 851 where the belt pairs 819, 829 release the interposed film strip 808. The belt pairs 819 and 821 separate at this location and are directed in opposite directions by rollers 821 and 839. The belt pair 829 are then moved about pulleys 837, 835 and 833 back to roller 831 where the belt pair 829 are once again placed in cooperative opposed relationship to belt pair 819 to capture an interposed film strip 808. Once the film strip 808 is transported through the nip of rollers 821 and 839 and released from the belt pairs 819, 821, it is then either recirculated through the scanner 301 or directed to a take-up roll (not shown) depending upon the position of a movable divertor guide 853.

The divertor guide 853 may consists of a curved surface that is pivotally movable about a pivot point 857. The divertor guide 857 is movable between a first position (shown in solid) and a second position (shown in phantom). In the first position, the divertor guide 857 functions to recirculate the film strip back between belt pairs 819 and 821 where the film strip is again transported to the scanner 301. Image files of the various images on film strip 308 are created with each pass of the film strip 808 through the scanner 301. The image files are thereafter combined to produce an optimal image as discussed above in connection with FIG. 13.

In its second position, the divertor guide directs the film strip 808 toward the take-up reel (not shown). The divertor guide 857 may be moved from the first recirculating position to the take-up reel position manually or automatically to recirculate the film strip 808 the appropriate number of times it is desired to scan the images for optimum processing.

As will be apparent to those skilled in the art from the above description, it is highly advantageous to transport a film strip in a film processing system without hindering processing of the portion of the film containing the latent image to be developed, which image typically is contained only on the central portion of the film. Transporting the film without blocking or hindering processing on the central portion of the film is particularly advantageous for digital film developing system, such as system 300 depicted in FIG. 13. In addition to the need to apply developing solution to, and avoid the disturbance of, the central portion of the film, digital processing also optimally requires light or other radiation to be reflected off both the top and bottom sides of the film, and to be passed through the film. Transporting the film in a manner that permits easy unencumbered access to the portion of the film containing the latent images greatly facilitates scanning of images in a production environment, particularly when it is desirable to transport the film through multiple processing units.

Thus, in accordance with the principles of one aspect of the present invention, the belt assembly 810 advantageously transports photographic film without blocking or otherwise interfering with access to the central portion of the film during the development process. This is achieved by contacting the film strip 808 only on its lateral portions with first and second pairs of spaced belts that run along a process path extending through the developer station 812 and each of the processing units 302, 304 and 306. This relative relationship between the film strip 808 and the belt assembly 810 is best depicted in FIG. 13a, wherein a first set of spaced belts 830, consisting of individual belts 830a and 830b is shown in contact with opposite lateral portions of a first of top surface of the film strip 808. A second pair of spaced belts 832, consisting of individual belts 832a and 832b is shown contacting corresponding lateral portions on the second or bottom surface of the film strip 808. The spacing between the individual belts 830a and 830b in the first set optimally variable, and is selected to accommodate the width of the film strip 808 being processed. The distance of this spacing may be adjustable to accommodate different film types and sizes. Once an appropriate spacing is selected for the distance between the belts 830a and 830b in the first set of belts, a similarly appropriate spacing is selected for the distance between the individual belts 832a and 832b in the second set. This spacing for the second set of belts 832a and 832b is typically the same spacing selected for the first set of belts 830a and 830b. By arranging the belts in this manner, one of the belts in the first pair, e.g. belt 830b cooperates with a corresponding belt in the second pair, 832b, to capture one lateral side of the film strip 808. The other belts in each pair of belts, 830a and 832a, similarly cooperate to capture the opposite lateral side of the film strip 808. Significantly, none of the belts touch or come into contact with the central portion of the film strip 808 that contains the latent image 104.

As will be appreciated by viewing FIGS. 13 and 13a, the two pair of belts 830a, 830b and 832a, 832b are guided along the process path by a series of rollers or pulleys. The belts 830a, 830b and 832a, 832b can be formed of steel or another appropriate metal with a polyurethane guiding strip bonded to the surfaces of the belts that come into contact with the pulleys. The guiding strip tracks in grooves in the pulleys and insures that the belt travels in a straight path. The pair of bottom belts 832a, 832b may be coated with urethane on the side of the belts that interfaces with the film strip 808 to provide increased fiction. The pair of bottom belts 832a and 832b can be driven by a single drive motor so as to move the belts 832a, 832b in unison. The top pair of belts 830a, 830b may also have an urethane coating of their film strip interface side (the side facing the film strip 808) for increased friction. The top pair of belts 830a, and 830b may be frictionally engaged to the filmstrip 808 interposed between the pairs of belts 830a, 830b and 832a, 832b and driven by same drive motor as the bottom pair 832a, 832b. Alternatively, one of the pulleys for the top pair belts 830a, 830b may be mechanically interconnected to the drive for the bottom pair of belts 832a, 832b to drive the top pair of belts 830a, 830b in unison with the bottom pair 832a, 832b. As a further alternative, the top and bottom pairs of belts could be interconnected by small pegs on the lateral edges of one of the pairs that extend toward and engage correspondingly shaped holes on corresponding lateral edges of the other pair of belts. Whatever the technique used for interconnecting the first and second pairs of belts, when the first or top pair of belts 830a, 830b is moved in unison with the second or bottom pair 832a, 832b and the belts compressingly or otherwise frictionally engage the film strip 808, the first and second sets of belts cooperate to capture and transport the film strip 808 along the process path through the film processing system 300.

Referring once again to FIGS. 13 and 13a, it can be seen that the film strip 808 is introduced into the processing system 300 between the two sets of convergingly rotating endless belts 830 and 832 at an inlet area, generally designated by the numeral 840. The belt set 830 is fed to the inlet area 840 from a pair of pulleys 850, comprising pulleys 850a and 850b (see FIG. 13a), and the belt set 832 is fed to this inlet area 840 from a pair of pulleys 852, comprising pulleys 852a and 852b. The belt sets 830 and 832 cooperatively converge at the inlet area 840 to contact opposite surfaces of the film strip 808 to capture the film strip 808, which is then interposed and frictionally captured between the two belt sets 830, 832. The joined belt sets 830 and 832, along with the interposed film strip 808 is then directed by a pair of entrance pulleys 854 (only one of which is shown) to application pulleys 856 (only one of which is shown) of the developer station 812 where the developer nozzle 814 applies a developer solution to the central portion of the film strip 808. As previously explained, the belt set 830 contacts the first or top surface of the film strip 808 only on the film strip's lateral sides, permitting easy access the central portion film strip 808 containing the latent images 104. After application of the developer solution, the belt sets 830 and 832 sequentially transport the film image to the first processing unit 302, second processing unit 304 and third processing unit 306. As previously noted, the processing units 302, 304 and 306 of the illustrated embodiment are scanning stations that scan the film strip 808 at different selected development times, and the resultant image files created at the various scanning stations 302, 304 and 306 are optimally combined to produce a digitally created photograph. In order to direct the belt sets 830 and 832 and interposed film strip 808 from one processing unit to another, one or more idler pulley sets are employed. For example, a pair of idler pulleys 860 (only one of which is shown)are used between processing units 302 and 304. Three idler pulley sets, 862, 864 and 866 are shown between the processing units 304 and 306 as the belt sets 830,832, and film strip 808 captured between the belt sets, is transported vertically for a predefined distance to allow the film strip 808 to undergo a prescribed development time as it travels between the processing units 304 and 306 without excessive spacing between the units and unduly adding to the floor space occupied by the various processing units.

The principle of capturing the film strip 808 on the side without blocking or otherwise interfering with access to the central portion of the film during the development process also can be achieved by capturing the film strip by belts on only a single side of the film strip 808 as depicted in FIG. 13b. When capturing the film strip 808 on only a single side as shown in FIG. 13b, it may be desirable to provide subjacent support of the lateral portion of the film strip 808 from the side opposite the belt capture side with a movable or static support. Alternatively, as depicted in FIG. 13b, the side of the film strip 808 opposite the belt capture side may be cantilevered.

As the film exits from the last of the three processing stations depicted in FIG. 13, it travels over a pair of exit pulleys 868 to an exit area 870 where the belt sets 830 and 832 are directed in different directions to release the interposed film strip 808. The film strip 808 is then wound up on a take-up reel (not shown). The belt set 830 then travels around a pair of idler pulleys 874a and 874b (only one of each set is shown in FIG. 13, see FIG. 13a) from which it is directed back to a pair of pulleys 850 back to the inlet area 840. The second or lower set of belts 832 is directed from the exit area 870 toward a pair of drive wheels 876a and 876b (only one of which is shown in FIG. 13, see FIG. 13a), which is driven by a suitable drive assembly 880.

According to another aspect of the present invention, the location and orientation of the film strip 808 is carefully controlled as it passes through the scanning units 302, 304 and 306. The optics in many current scanners have a relatively narrow depth of field and require relatively precise positioning and orientation of a film strip in order to insure a high quality and reproducible scan. The present invention carefully controls the position and orientation of a portion of a film strip being scanned through the use of a rotatable control surface. More particularly, as best illustrated in the drawing of FIG. 15, the belt sets 830 and 832, and thus the interposed film strip 808, is directed through an image area 824 of the scanners at which location the film strip 808 is being scanned. As scanning occurs at this location 824, the belt sets 820, 830 and film strip 808 are being urged against the outer surfaces of a pair of side-by-side rollers 910 and 912 (see FIG. 14), which surfaces rotate relative to the axis of a stationary shaft 914. In the system depicted in FIG. 13, this urging is accomplished by positioning the idler rollers above the lowest extension of control surface 940 and maintaining the belt sets 830 and 832 in tension. In the embodiment of FIGS. 13 and 15, the rollers 910 and 912 are powered by their frictional engagement with the belt set 830 to move in timed relationship with the belt sets 830 and 832.

The rollers 910 and 912 are of equal size and diameter, 4 inch diameter rollers in the exemplary embodiment, with each roller having a curved or arcuate configuration outer surface. Due to their equal size and arcuate configuration, the outer surfaces of these two rollers 912 and 914 define an image plane in a direction generally orthogonal to the direction of curvature of the surface. The film strip 808 will follow the belts around the rollers with the developing layer concave-up to the inside of the control surface. Thus, as the film strip 808 is transported over the imaging area 824, the control surface 940 insures that the film strip 808 is both accurately positioned and flat (maintained in an image plane) during the scanning process. The roller 910 is an axially static in that it is not axially movable relative to the shaft 914. If desired, however, the roller 912 may be indexable or axially movable for the purpose of adjusting the spacing between rollers 910 and 912 to accommodate film of varying sizes. The axial spacing of the rollers 910 and 912 can correspond to the spacing of selected spacing between the individual belts in the belt set 830. With such spacing, contact between the control surface and the central portion of the film strip 808 is advantageously avoided, and this central portion of the film strip 808 is can be easily scanned without interference from the transport system.

Scanning of the film strip 808 at the scanning area 824 also is facilitated by a slot 915 in the stationary shaft 914 that is aligned with the spacing between the rollers 910 and 912. This aligned slot 915 provides a line of sight for a sensor 820 located above the control surface 940. It also will be noted that radiation sources and wave guides 817a and 817b on the front side of the film strip 808 may be located above the film strip in the space between the rollers 910 and 912.

FIGS. 16 and 16a show an alternative embodiment of the control surface aspect of the present invention. In this embodiment, film 808 is inserted into the nip of a pair of counter-rotating rollers, a pair of high friction drive rollers 600 and a pair of back-up rollers 602. Individual rollers 600a, 600b, 602a and 602b in each of these pairs of rollers are shown in the illustration of FIG. 16a. The film strip 808 is then fed across a control plane surface 940 formed by a pair of side-by-side rollers 604 (only one of the rollers being shown in the drawing). A second pair of counter-rotating rollers, a high friction drive roller 606 and a back-up roller 608 are positioned on the opposite side of the control plane surface from the rollers 600 and 602, and the film strip 808 is fed into the nip of this second pair of rollers 606, 608. Each of the drive rollers 606 and 608 may be driven, with the drive roller 606 being driven faster than drive roller 600. This disparity in speed puts the film strip 808 in tension which causes the film to pull tightly against the control surface 940. However, the drive roller 606 also is equipped with a slip clutch so as to prevent the application of excessive tension on the film strip 808. Thus, the speed of drive roller 600 can be used to control the speed of the film strip 808 and the drive roller 606 may be used to control the tension of the film strip 808 across the control surface. Like the previously described control surface, the control plane surface 940 depicted in FIG. 16 consists of two rollers spaced in correspondence with the film size so as to contact the film strip 808 only at its lateral edges, leaving the central portion containing latent images (on which developer solution may have been placed) untouched. Similarly, when urged against the control surface 940, the film 808 is transported in the scanning area between the wave guides 817a, 817b and 819a, 819b in flat plane orientation in the image plane 940.

A further modification of the control surface aspect of the invention, shown in FIG. 17, employs a pair of relatively small, stretchy, high friction belts 700 to urge the film strip 808 against the control surface 940. The two friction belts 700 (only one of which is shown in FIG. 17) contact opposite lateral sides of the film strip 808 and urge the film strip 808 into the proper position and orientation for scanning. The friction belts 700 extend between pairs of rollers 702 and 704 on opposite sides of the control surface 940. It may be desirable to apply drive power to the image rollers, and use the pairs of end rollers 702 and 704 as idler pulleys.

Although film may be directly driven through the digital film development systems discussed above, FIG. 18 illustrates an alternative method and system for driving film through such a system, according to another aspect of the present invention. In this embodiment, film 220A and film 220B are applied to a tape or belt 520. Any suitable attachment device or substance can be utilized to attach the film 220A and 220B to the tape 520, such as an adhesive for example. Once the film is attached, the tape 520 can be directly driven through the film development system, such as by using sprockets or rollers for example. Sprocket holes 522 may be provided on the edges of the tape 520 in order to drive the tape using a sprocket system.

As shown in the example of FIG. 18, the tape 520 extends from the side edges 530A of the film strip 220A, as well as from the side edges 530B of the film strip 220B, thereby defining tape extension portions A. These portions A can be contacted and moved by a film transport mechanism, near the side edges 521 and 523 of the tape 520. For instance, the sprocket holes 522 on the extension portions A can be engaged by a sprocket to directly transport the tape 520 and indirectly transport the attached film strips 220A and 220B.

The tape 520 can be made from a base of plastic, polyester, acetate polypropylene, polyvinyl chloride, mylar, paper, or other suitable materials. An adhesive, such as an acrylic or rubber resin adhesive for example, can be used to secure the film strips 220A and 220B. It is also preferred that the tape 520 and adhesive are substantially transparent to the scanning radiation so as to provide little or no interference in the scanning process. For example, if infrared light is used for scanning the film strips 220A, 220B, then the tape 520 should be substantially transparent to the infrared light used. The adhesive and/or tape may also include one or more developer substances to assist in the development of the image on the film and/or any data on the film such as bar codes which are included near the edges of the film.

By use of such a tape 520, the system may easily accommodate a variety of film sizes. For example, film 220A might comprise an APS film strip, while film 220B might comprise a 35 mm film strip. The tape 520 should be sufficiently wide to accommodate a variety of film widths (i.e., W0>W2>W1). Thus, the same film transportation development system can be used to scan a variety of film types, and separate hardware systems and components need not be manufactured for separate film types. Accordingly, neither the widths (W1 and W2) nor the size or spacing of the sprocket holes 527 need to be consistent between films 220A and 220B which are scanned by the digital film processing system.

In addition, use of tape 520 allows for the placement of alignment marks 524 at various places along the tape 520. These marks 524 may be read by the digital film processing system to assist in interpreting and aligning digital image data files, and ensuring proper alignment of frames during the digital film development process. For instance, such marks 524 could be readable by infrared cameras, magnetic heads, scanning devices, or other devices, to thereby provide a feedback reference signal which could be used for identifying the locations of various frames, various film strips, various development times, etc. Also, such marks 524 could be used to provide feedback to the transport motors to control the transport rate of the film through the system. This feedback could also be used to initiate or trigger the film image scanning processes at various points in the development of the film. Moreover, such marks 524 can be used to generate digital data during the digital scanning process which can be used to align the various digital images taken from the various film layers and/or from the various film development times. The marks 524 can be placed at uniform intervals along the length of the tape 520. For example, the marks 524 could be placed after every n sprocket holes 522, where n is a positive integer.

FIG. 19 illustrates another potential advantage of using tape 520 to transport film 220. In this embodiment, the tape 520, and attached film 220, are driven by using a set of drive wheels 526 which pinch the tape 520 near its side (transverse) edge 521, and another set of drive wheels 528 to pinch the tape 520 near its opposite side edge 523. Developer 528 is applied to a top surface 226 of the film 220 to allow the film to develop as it is scanned by scanning or imaging devices, such as those described above with respect to FIGS. 1-3. If the edges of the film 220 were directly driven by the wheels 526 and 528, then the developer 528 might form beads near the edges of the film 220 which are thicker than other areas of the developer. These beads could interfere with the scanning process and the resulting digital image. However, in the embodiment of FIG. 19, because the tape 520 is wider than the film 220, the developer 528 can spill out over the edges 530 of the film. Although beads 532 might still form near the edges 530, as shown in FIG. 19, these beads 532 will not interfere with scanning operations if they are outside of the edges 530.

Moreover, if the film 220 were driven directly by a driving device, such as a driving wheel 528 or a sprocket, the developer 528 may fail to completely cover the frame to be scanned, thereby making the development of the frame, and the latent image thereon, inconsistent. Also, in such a direct film drive configuration, developer 528 might make contact with and interfere with the driving device, thereby requiring frequent maintenance and cleaning. Moreover, information, such as film type and aspect ratio information, that is recorded near the film edge 530, can be rendered unreadable if the film is directly driven by the drive device. Certain film types, such as APS film for example, include a magnetic and/or optical strip near the film edge 530 which includes information regarding each frame, and this strip might be rendered unreadable if the film 220 is directly driven by both edges. In addition, some film manufacturers provide bar codes along the film edge(s) which provide information regarding the composition of the film emulsion, and such bar codes may be rendered unreadable if the film 220 is directly driven by both edges. Moreover, directly transporting film through a digital film processing system can cause a portion of the latent image on the film to be masked.

However, as shown in FIG. 19, when the film 220 is indirectly driven by use of the tape 520, the developer 528 can completely cover the entire width of the film in a substantially even layer. Moreover, the risk is reduced that the developer 528 will contact the drive wheels 526 and 528 or otherwise contact film transportation and scanning equipment, such as by falling through sprocket holes for example, and thereby interfere with the operation and/or require more frequent maintenance/cleaning. In addition, the tape 520 can be made sufficiently wide to allow for large areas near to be contacted and driven by the drive wheels 526 and 528, thereby providing a better grip on the tape and reducing the chance of wheel slippage, or other transport errors. In addition, using a tape attachment 520 such as shown in FIG. 19 allows film developer the bar codes along the side edges 530 of the film 220 to develop, such that the bar codes may be read and utilized by the digital film processing system. Moreover, using the tape attachment 520 allows magnetic, optical, and/or other data recorded on the side edges 530 of the film 220 to be read and utilized during the digital film development process. For instance, aspect ratio data could be read from APS film to adjust the size of the image which is printed from the resulting digital data. Moreover, the tape attachment 520 prevents edge portions of the latent image on the film 220 from being masked by a film transport device, as the tape attachment 520 can be contacted by the device instead of contacting the film directly.

FIGS. 20 and 21 illustrate potential ways in which tape can be applied to film for transporting through a digital film processing system. In the embodiment of FIG. 20, an adhesive 536 can be applied to a surface 540 of the tape 520. The bottom surface 228 of the film 220 can then be bonded to the surface 540 of the tape 520. Once the film 220 and tape 520 are bonded, the areas A of the tape 520 will extend from the edges 530 of the film 220. These areas A of the tape 520 can be engaged by a drive device for transporting the tape/film combination.

In the embodiment of FIG. 21, two portions of tape, 520A and 520B, can be bonded near the opposing side edges 530 of the film 220. The adhesion areas B of the tapes 520A and 520B will bond to the film 220, leaving the extension areas A of the tape 520A, 520B extending from the side edges 530 of the film 220. Thus, the extension areas A can be engaged by a driving device for transportation of the tape/film combination. Moreover, in this exemplary configuration of FIG. 21, it is preferred that the areas B of the tape do not cover any images or recorded information on the film 220. Accordingly, such a configuration will minimize the risk that either tape 520A or 520B will interfere with any light which is applied to the film 220 during scanning. Also, such a configuration will allow the tape 520A and 520B to be opaque or transparent to the scanning radiation.

Other variations are also possible. For instance, the edges of the tape may be doubled over and joined so as to prevent any tape adhesive from being exposed to the film or hardware. Such a configuration is shown in FIG. 22. As shown in this figure, the edge 521 of tape piece 520A has been folded back to be adjacent the first edge 530A of the film 220, and the edge 523 of the tape piece 520B has been folded back to be adjacent the second edge 530B of the film 220. Thus, adhesive on the upper surfaces 535 of the tape pieces 520A and 520B will be substantially covered and prevented from contacting other equipment and surfaces.

Other alternative configurations are also possible. Adhesive may be present only between the film 220 and tape 520, to thereby better prevent interference by exposed adhesive. Moreover, as another alternative, tape may be applied to a single edge 530 of the film 220 rather than to both edges of the film. The width of the tape can then be adjusted such that the film 220 will be approximately the width of a larger sized film, and can thereby be used in transportation systems designed for the larger sized film. In such a configuration, one edge of the film 220 and one edge of the tape 520 are moved by the film transport system.

FIG. 23 illustrates an embodiment of a digital film processing system 305 which can utilize the tape transportation configurations described in FIGS. 18-22. Included in the system 305 is a tape supply dispenser 568, and a film/tape joiner 572. The joiner 572 joins the tape to the film, such as in the manner described above with respect to FIGS. 18-22. In this embodiment, a number of rollers 466 are provided for contacting and guiding the tape side edges. For driving the tape and attached film through the system, a capstan drive 464 is provided near the leading side 476 of the system 305. The capstan drive 464 can include a motor or other actuator which provides rotary motion, as well as a pair of pinch rollers 465. The pinch rollers 465 are rotated by the force of the actuator, and the tape is pinched between the rollers 465 to contact the tape edges and force the tape through the system 305, which in turn forces the attached film through the system. Near the opposite side of the system 305 is a tensioner 462 which includes a pair of pinch rollers 467. Tape is moved between the rollers 467 which contact or pinch the tape edges and provide a resistance to the movement thereof. The resistance that is provided by the tensioner 462 can be adjustable, such as by adjusting the contacting force applied between the rollers 467. As noted above, it is preferred that rollers 465, 466, and 467 directly contact only the tape. However, it is contemplated that these rollers could contact the tape on one side edge and the attached film on an opposite side edge, as noted above.

When the tape and attached film is transported through the system and the first film frame has reached the dispenser 310, developer is applied to the frame via this dispenser 310, which can comprises a slot coater (SC) for example. The film frame then begins to develop as it travels the path indicated. A first imaging module 502 scans the film frame and produces a first digital image file at a first film development time. As the film frame 220 continues to travel through the system 303, it continues to develop until it reaches a second imaging module 504 where a second image data file is produced at a second film development time. The film frame develops further until it reaches the third imaging module 506 which creates a third image data file at a third film development time. The three image data files are then stitched together to produce one image data file which includes aspects of the image on the frame from all three development times of the frame. Accordingly, the total development time for the film frame before being imaged by the last module 506 is the amount of time that the frame takes to travel from point A, where developer is applied by the dispenser 310, to point B, where the last image data file is created by imaging the frame. A take-up roll 574 can gather the tape and attached film at the end of the process.

The exemplary digital film development systems described above may utilize a number of devices, materials, and methods for introducing a film strip into the system. For example, according to one aspect of the invention and as shown in FIG. 24, a leader strip 440 is serially joined to the film strip 220 at splice point 442, such as by adhering the trail edge 441 of leader strip to (or near) the lead edge 443 of the film strip or by otherwise attaching the two strips. (The trail and lead edge of the leader 440 each connect longitudinal side edges S1 of the leader 440, and are opposite one another. Likewise the trail and lead edges of the film strip 220 each connect longitudinal side edges S2 of the film strip, and are opposite one another.) Then, the leader 440 can be hand threaded through the exemplary digital film development system 301. In particular the leader 440 may be threaded through a transport system 309a. In this exemplary embodiment, the transport system 309a comprises a first pinch roller mechanism 435, a second pinch roller mechanism 437, and a third pinch roller mechanism 439. Each pinch roller mechanism 435, 437, and 439 has a pair of front wheels 436F joined by a shaft 438 and a pair of back wheels 436B joined by a shaft (not shown). For each of the three pinch roller mechanisms, the leader 440 is threaded between a wheel 436F and a wheel 436B at one transverse edge of the leader, and is also threaded between a wheel 436F and a wheel 436B at an opposite transverse edge of the leader. Additional pinch roller mechanisms can be provided as needed.

The exemplary transport system 309a also includes a driving pinch roller mechanism 433 that includes wheels 432 F connected by a shaft 434 and wheels 432 B connect by a shaft (not shown). The transverse edges of the leader 440 is threaded between wheels 432F and 432B. The shaft 434 is driven by a drive mechanism 430, which can comprise a motor, such as an AC or DC motor for example, or can comprise a capstan drive assembly, for instance. Once the leader 440 is threaded through this last set of wheels 432F and 432B, the drive mechanism 430 can be activated to rotate the wheels 432F and/or 432B to pull the leader 440 and attached film 220 through the other three passive pinch rollers 435, 437, and 439, which will rotate due to the force of the moving leader. Thus, the drive mechanism 430 essentially pulls or drags the leader 440 and attached film 220 through the system 301 via the active pinch roller mechanism 433. The roller mechanisms 435, 437, and 439 are passive and provide some resistance to this pulling force tensioning the leader 440 and film 220 as it is pulled through the system. Tensioning the film 220 can be advantageous as it reduces film buckling and wrinkling, and ensures that frames are flat and taut while being scanned. Preferably, the tension is substantially uniform between the various pinch roller mechanisms of this example.

As the film 220 travels through the film development system 301, the film 220 can be tensioned or shaped into an arcuate shape 444, such as by using an arcuate support surface or arcuate edge guides for the film. Front and back scanning stations 446F and 446B can record the front, back, front-through, and/or back-through signals while the developing film is in the arcuate shape. These stations 446F and 446B can include front and back radiation sources and sensors, such as those discussed above with respect to other digital film development embodiments. Preferably, the stations 446F and 446B of this exemplary embodiment are separately mounted and easily removed from the system 301 when desired.

According to another aspect of the invention, because the transport system 309a of FIG. 24 includes only one drive point along the length of the film 220 (via drive mechanism 430), the risk of film jamming and buckling is reduced. Multiple drive assemblies at other points along the length of the film 220 can create a higher risk that jamming or buckling will occur, unless the drive speeds of the multiple assemblies are precisely matched. Moreover, because leader 440 is utilized in the digital film development system 301 of FIG. 24, the film 220 does not need to be manually handled and threaded through the system. Rather, the film 220 need only be attached to the leader 440 which will then lead the film 220 through the system, thereby minimizing handling of the film 220 and decreasing the risk that the film will be damaged, marked, or otherwise adversely affected.

As shown in FIG. 25, once the lead edge 447 of the leader 440 has been threaded through the system 301 in the direction shown, it can be looped back around and attached to (or near) the trail edge 449 of the film strip 220 at splice point 448. Accordingly, the film 220 and leader 440 are spliced at points 442 and 448 and form one continuous loop. An advantage of attaching the leader 440 to the trail edge 449 of the film 220 is that the leader 440 need not be hand threaded through the system 301 to introduce a new film strip once the first film 220 has been processed by the system 301. Rather, the leader 440 will follow the first film strip 220 through the system 301 as the film is being scanned by the stations 446F and 446B, and thus, will be automatically re-threaded and ready for the next film strip to be processed. Once processing is complete on the film 220, it can be disconnected or freed from the leader 440. The leader 440 will remain threaded in the system 301 and will have an edge ready for splicing to the next film strip which is to be digitally developed. Subsequently, in the exemplary embodiment of FIG. 25, the operator of the system 301 need only open the system once to hand thread the leader 440 the first time. The leader 440 will be automatically threaded for subsequent uses. In addition, because the leader is re-circulated by attachment to the trailing film edge, the same leader strip 440 can be used to process multiple film strips. Accordingly, the expense of using a separate leader strip for each film strip can be avoided.

FIG. 26 shows another alternative embodiment of a digital film development system 301′. In this embodiment, two leader strips are provided, 440L and 440T, one being threaded through the system and spliced at point 442 to the lead edge 443 of the film 220, and the other being spliced at the point 448 to the trail edge 449 of the film 220. As in FIG. 25, the system of FIG. 26 requires a leader to be manually threaded once. Then, the film 220 can be spliced at point 442 to this first leader 440L, and the film can be spliced at point 448 to the second leader 440T, supplied from roll 450. Once the first leader 440L and film 220 is pulled past the drive mechanism 430, they can be taken up or wound on roll 452. The trailing leader 440T will then be automatically threaded through the system 301′ because it follows the film 220 due to the splice at point 448. The exposed end of the trailing leader 440T can then be cut and spliced to the next roll of film 220 to be processed by the digital film development system 301′.

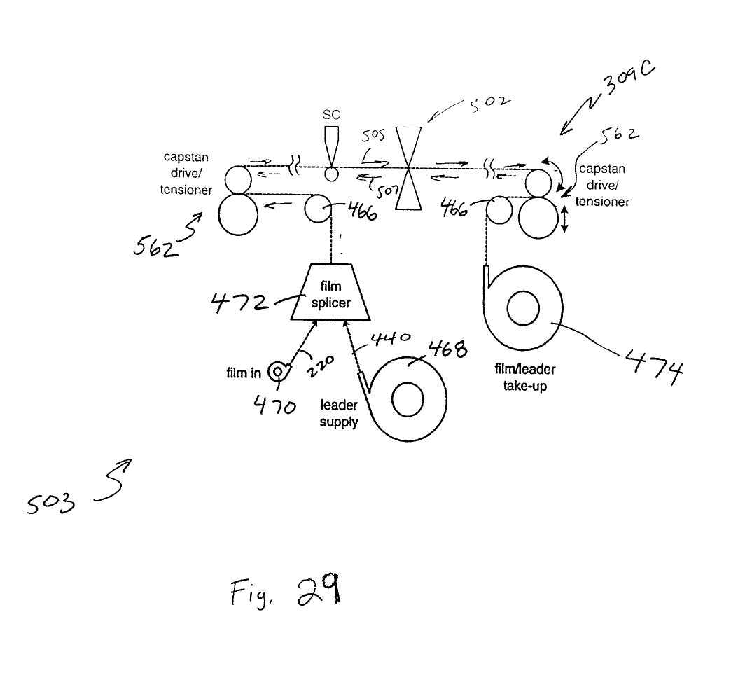

FIG. 28 illustrates an alternative digital film development system 303 that splices a leader to the film 220. In this embodiment, the transport system 309b of the digital film development system 303 includes a number of rollers 466, around which the film and leader are led for transportation through the system 303. For driving the film 220 and attached leader through the system 330, the transport system 309b includes a capstan drive 464 near the output side 476 of the system 303. The capstan drive 464 can include a motor or other actuator which provides rotary motion, as well as a pair of pinch rollers 465. The pinch rollers 465 are rotated by the force of the actuator, and the film 220 is pinched between the rollers 465 to force the film through the system 303. Near the opposite side, or input side 478, of the system 309b is a tensioner 462 which includes a pair of pinch rollers 467. Film and attached leader are moved between the rollers 467 which contact or pinch the film/leader and provide a resistance to the movement thereof. The resistance that is provided by the tensioner 462 can be adjustable, such as by adjusting the contacting force applied between the rollers 467. Any adjustable mechanism for moving the rollers 467 of the tensioner 462 into tighter contact may suffice for this purpose.

According to this aspect of the invention, the single capstan drive 464 pulls the film/leader through the system 303, and the resistance provided by the tensioner 462 and/or other rollers 466 provides tension in the film for preventing buckling and jamming of the film and providing more accurate imaging. The tension provided can be adjusted by adjusting the tensioner 462, and the speed of the film travel can be adjusted by adjusting the capstan drive 464.

The film 220 can be fed from a dispenser 470, and the leader 440 can be fed from a dispenser 468. The leader 440 can be spliced to the front and back ends of each film strip 220, such as discussed above. A splicer 472 can be utilized to assist in joining the leader 440 and film 220.

When the leader 440 has been fed through the system and the first film frame F has reached the dispenser 310, developer is applied to the film via this dispenser 310, which can comprises a slot coater (SC) for example. The film frame F then begins to develop as it travels the path indicated. A first imaging module 502 scans the film frame F and produces a first digital image file at a first film development time. As the film frame 220 continues to travel through the system 303, it continues to develop until it reaches a second imaging module 504 where a second image data file is produced at a second film development time. The film frame F develops further until it reaches the third imaging module 506 which creates a third image data file at a third film development time. The three image data files are then stitched together to produce one image data file which includes aspects of the image on the frame F from all three development times of the frame. Accordingly, the total development time for the film frame F before being imaged by the last module 506 is the amount of time that the frame takes to travel from point A, where developer is applied by the dispenser 310, to point B, where the last image data file is created by imaging the frame.

FIG. 29 illustrates an alternative to the system 303 of FIG. 28. In this embodiment, a system 503 operates in a manner similar to the system 303 of FIG. 28. However, the system 503 of FIG. 29 utilizes a single scanning module 502, thereby reducing equipment size and cost, according to another aspect of the invention. Scans can be taken at multiple development times by the system of FIG. 29 by providing a transport system 309c having a pair of combination drives/tensioners 562 on either side of the module 502. These drive/tensioners 562 can drive the film through the scanning module 502 in either the forward 505 or the reverse 507 direction. Thus, the drives/tensioners 562 each can include a reversible, or bi-directional, motor or actuator. To take a first scan of a frame or frames, the film 220 may be driven through the module 502 in the forward direction 505. Once these first scans are completed, then the drive/tensioners 562 may be reversed to drive the film 220 through the module 502 in the reverse direction 507. A second development time scan can be taken during this reverse motion, resulting in multiple scans at multiple development times. Alternatively, the film 220 can be quickly reversed by the drive/tensioner 562 without scanning taking place, and then driven in the forward 505 direction at a second development time, during which the second scan may take place. As another alternative, the film 220 and leader 440 can be attached into a loop, and the entire loop passed through the scanning module 502 during multiple development times of the film 220. The tension applied to the film/leader strip can be adjusted by adjusting the resistance force applied by the drive/tensioners 562. Moreover, when one drive/tensioner 562 is actively driving the film/leader, the other drive/tensioner can provide resistance to the driving direction, such that tension is provided in the film/leader for more accurate scanning and film transportation.

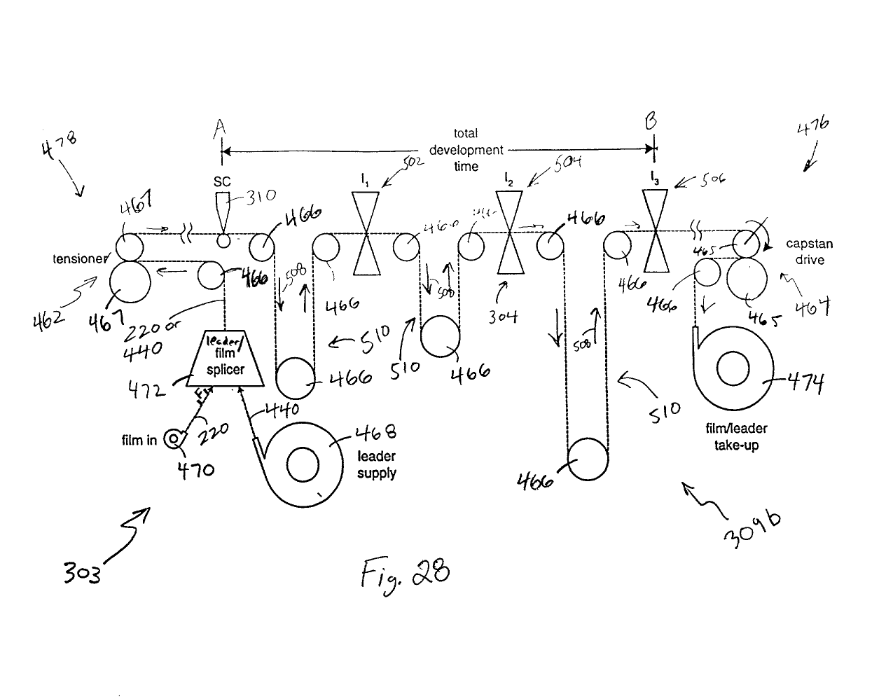

FIGS. 27a, 27b, and 27c illustrate a transport element comprising a roller 460 which can be used in a transport system to transport both film and any leader that may be attached thereto, according to another aspect of the invention. Such a roller 460 could be used as one alternative to the roller mechanisms shown in FIGS. 24, 25, and 26.

In this embodiment of the roller 460, a pair of sprockets 462L and 462R are connected by a barrel-shaped hub or crown roller 466. The sprockets 462L and 462R are spaced approximately the width of a typical film strip, such that the sprocket teeth 464 can engage the sprocket holes which are typically found on a strip of film. The sprocket teeth 464 should be appropriately spaced along the sprockets 462L and 462R so as to match the spacing of sprocket holes on the edges of typical film rolls or strips. The sprockets 462L and 462R can be interchangeable with crown rollers 466 of differing widths W, such that a variety of film widths may be accommodated.

The roller 460 of FIGS. 27a, 27b, and 27c can accommodate a leader which does not have sprocket holes on its edges, and can also center such a leader onto the roller. Thus, an inexpensive leader material can be utilized. For example, the leader 440 which was discussed above with respect to FIGS. 24, 25, and 26 may comprise an adhesive-less tape material which does not have sprocket holes. Plastic, metal, or cellophane materials or other appropriate strips or bands of material may be utilized for such a leader tape 440. Such a leader 440 can ride on the outer surface 468 of the crown roller 466 as it is fed through the system. Once the trailing film 220, which is spliced to the leader 440, arrives at the roller 460, the teeth 464 will engage the sprocket holes on the edges of the film. Any trailing leader which is spliced to the trail end of the film would then ride on the crown roller 466. Such a configuration is shown in FIG. 27b. The film 220 rides on the teeth 464 of the wheels 462, and the leader 440 rides on the crown roller 466. The trailer strips 440 would need to be slightly more narrow than the film 220 in order to work in such a manner. In particular, to ride on the crown roller 466, the trailer strip 440 would have a width of less than the width W shown in FIG. 27c.

The outer surface 468 of the crown roller 466 can be arcuate or barrel-shaped in its longitudinal direction, as shown in FIG. 27c, to keep the leader centered. With such a configuration, because the portion P of the crown roller 466 with the largest diameter has a higher rotational velocity than the remainder of the crown roller, the leader remains centered on the crown roller. Thus, the transport roller 460 of FIGS. 27a, 27b, and 27c is a dual function roller capable of transporting film with sprocket holes as well as inexpensive leader material that has no sprocket holes. Because the film is engaged at its edges by the sprockets, the center surfaces of the film need not be contacted, and any risk of damaging these surfaces is reduced.

The foregoing descriptions of the exemplary embodiments of the invention have been presented for purposes of illustration and description only. They are not intended to be exhaustive or to limit the invention to the precise forms disclosed, and modifications and variations are possible and contemplated in light of the above teachings. While a number of exemplary and alternate embodiments, methods, systems, configurations, and potential applications have been described, it should be understood that many variations and alternatives could be utilized without departing from the scope of the invention. Moreover, although a variety of potential configurations and components have been described, it should be understood that a number of other configurations and components could be utilized without departing from the scope of the invention.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Accordingly, it is intended that the scope of the invention be defined by the claims appended hereto.

What is claimed is:

1. A method for creating a digital image file from a developing film, comprising:
applying developer to film to cause the film to begin to develop.
moving the developing film through a first scanning module adapted to create a first digital image of the film during a first film development time;
moving the developing film through a second scanning module adapted to create a second digital image of the film during a second film development time; and
moving the film through an opening between the first and second modules.

2. The method as recited in claim 1, further comprising:
combining the first and second digital image files to form a combined image file representing an image on the frame.

3. The method as recited in claim 1, further comprising:
opening a trap door between the first and second modules to create the opening.

4. The method as recited in claim 3, wherein the trap door is opened automatically upon sensing that the film has reached a predetermined position.

5. A digital film development transport system, comprising:
a film support adapted to support developing film;
a drive mechanism adapted to move the developing film over the film support; and
a trap door mechanism adjacent to the film support and adapted to move between a closed position configured to allow film to travel over the trap door mechanism and an open position configured to allow film to travel through an opening.

6. The system as recited in claim 5, wherein the trap door mechanism comprises
a hinge, the trap door mechanism being rotatable about the hinge.

7. The system as recited in claim 5, further comprising a film channel assembly positioned beneath the opening and adapted to contain film in a channel defined by the film channel assembly.

8. The system as recited in claim 5, further comprising:
an actuator adapted to control the position of the trap door mechanism;
a controller adapted to control the actuator upon detecting a position of the film.

9. The system as recited in claim 5, further comprising:
a film guide arm adapted to contact the film when the trap door mechanism is in the open position.

10. A method for creating a digital image file from a developing film, comprising:
applying developer to film to cause the film to begin to develop;
placing the developing film in tension;
applying radiation to a frame on the tensioned film during a first development time;
sensing first radiation from the frame during the first development time; and
creating a first digital image file using the sensed first radiation.

11. The method as recited in claim 10, wherein the film is placed in tension by the steps comprising:
rotating a first roller mechanism at a first speed;
contacting the film with the first roller mechanism;
rotating a second roller mechanism at a second speed; and
contacting the film with the second roller mechanism;
wherein the first speed is faster than the second speed.

12. The method as recited in claim 10, further comprising:
forming the film into an arcuate shape.

13. The method as recited in claim 10, wherein the first radiation comprises radiation reflected from the front of the film, radiation reflected from the back of the film, and radiation transmitted through the film.

14. A mechanism for tensioning film for scanning, comprising:
a first transport element adapted to contact the film and to move at a first speed;
a second transport element spaced from the first transport element, wherein the second transport element is adapted to contact the film and to move at a second speed;
wherein the first and second transport elements are adapted to tension the film therebetween.

15. The mechanism as recited in claim 14, further comprising:
a drive mechanism adapted to impart rotation to at least one of the first and second transport elements.

16. The mechanism as recited in claim 15, further comprising:
a slip device configured to disengage at least one of the first and second transport elements upon a torque overload.

17. The mechanism as recited in claim 14, further comprising:
an arcuate film bridge configured to form the tensioned film into an arcuate shape.

18. A modular digital film development system, comprising:
a first film scanning module including a first mounting member holding:
a film guide assembly adapted to receive developing film, a source of radiation, and a sensor adapted to sense radiation from the developing film; and
a second film scanning module including a second mounting member holding:
a film guide assembly adapted to receive developing film from the first module, a source of radiation, and a sensor adapted to sense radiation from the developing film;
wherein the first and second mounting members are separable members.

19. The modular digital film development system as recited in claim 18, wherein the first and second modules are substantially identical.

20. The modular digital film development system as recited in claim 18, further comprising:
a frame connected to the first and second mounting members.

21. A method for creating a digital image file from a developing film, comprising:
attaching a leader strip to a lead edge of the film;
threading the leader strip and attached film through first and second scanning modules, wherein the scanning modules are separable;
attaching tape to the film such that the tape extends from a film side edge;
applying developer to the film to cause the film to begin to develop;
contacting the tape with belts and moving the belts to move the tape and attached film through the first scanning module;
scanning the film using the first scanning module to create a first digital image of the film during a first film development time, wherein the film is placed in tension during the scanning;
moving the film through an opening between the first and second modules; and
scanning the film using the second scanning module to create a second digital image of the film during a second film development time.

22. In a film processing system, a system for transporting strip of photographic film, comprising:
(a) a processing unit, the processing unit having a process space for processing the photographic film;
(b) a first pair of belts spaced by a selected distance and extending along a process path through the processing space of the processing unit, the first pair of belts being spaced and adapted to contact opposite lateral portions of a first side of a film strip without contacting a central portion of the first side of the film strip between the opposite lateral portions of the first side;
(c) a second pair of spaced belts spaced by the predefined distance and extending along the process path through the processing space of the processing units, the second pair of belts spaced and adapted to contact lateral portions of a second side of the film strip without contacting a central portion of the film strip between the opposite lateral portions of the second side; and
(d) a drive assembly for moving the first and second sets of belts through the process space in unison, the first and second pairs of belts being arranged so that one of the belts in the first pair cooperates with a corresponding belt in the second pair to capture one of the lateral portions of the film and the other one of the belts in the first pair cooperates with a corresponding belt in the second pair to capture the other of the lateral portions of the film, the first and second sets of belts jointly transporting the interposed film strip along the process path without contacting the central portion of the film.

23. A film processing system as recited in claim 22 wherein the processing unit includes a radiation source and a sensor adapted to sense radiation from the film, the sensor being in communication with the radiation source via reflected or transmitted radiation from the film.

24. An apparatus for transporting a film strip having first and second sides through an scanning assembly, comprising:
a light source for passing light through a film strip as the film strip is passed through the scanning assembly;
a control surface operative to control the position and orientation of the film strip as the film strip is moved through the scanning assembly; and
a belt assembly including at least one movable belt operative to engage a first surface of a film strip and to urge the film strip against the control surface, the belt assembly and the control surface being jointly operative to capture an interposed film strip and move the interposed film strip in a predetermined orientation and position relative to the scanning assembly.

25. An apparatus as recited in claim 24 wherein the control surface is movable and moves in timed relationship with the belt.

26. An apparatus as recited in claim 24 wherein the belt assembly includes a first set of belts contacting the first surface of a film strip and a second set of belts contacting a second surface of the film strip.

27. A method of presenting a portion of a film strip to an imaging station, comprising the steps of:
(a) urging a portion of a film strip against an arcuate control surface;
(b) rotating the control surface to move the portion of the film strip to a scanning location;
(c) subjecting a portion of the film strip to a radiation source at the scanning location; and
(d) sensing radiation from the film strip at the scanning location.

28. A method as recited in claim 27 wherein the imaging station includes at least one belt moving in timed relationship to the rotating control surface and wherein the at least one belt is used to urge a portion of the film strip against the arcuate control surface.

29. A method for transporting film through a scanning system, the method comprising the steps of:
attaching a tape strip to a film strip such that a portion of the tape extends from a side edge of the film strip;
engaging the portion of the tape strip extending from the side edge of the film strip to move the tape strip and attached film strip; and
scanning the film strip attached to the tape strip to create a first digital image file.

30. The method as recited in claim 29, wherein the tape strip is engaged near at least one side edge of the tape strip.

31. The method as recited in claim 29, wherein the tape strip is engaged by a roller mechanism.

32. The method as recited in claim 29, wherein the tape strip has a width larger than 35 mm.

33. The method as recited in claim 29, wherein the attaching step comprises:
attaching a first tape strip to a first side edge of the film strip such that the first tape strip extends outwardly from the first side edge; and
attaching a second tape strip to a second side edge of the film strip such that the second tape strip extends outwardly from the second side edge.

34. The method as recited in claim 29, wherein the digital image file is created as the film is developing.

35. The method as recited in claim 29 further comprising:
scanning the film strip to create a second digital image file; and
combining the first and second digital image files to create a combined image file representing an image on the film strip.

36. A digital film development system, comprising:
a tape strip;
a film strip attached to the tape strip;
a transport mechanism adapted to contact the tape strip and to move the tape strip and the attached film strip;
a source of radiation adapted to apply radiation to the film strip; and
a sensor adapted to sense radiation from the film strip and to create a digital image file of an image on the film strip.

37. The system as recite in claim 36, wherein the film strip is more narrow than the tape strip.

38. The system as recited in claim 36, wherein the tape strip is substantially invisible to the radiation.

39. The system as recited in claim 36, wherein the sensed radiation comprises radiation reflected from the front of the film strip, radiation reflected from the back of the film strip, and radiation transmitted through the film strip.

40. A method for creating an image from film, the method comprising the steps of:
attaching a trailing edge of a leader strip to a leading edge of a film strip;
threading the leader strip through a film transport system;
using the film transport system to move the leader and attached film;
applying developer to the film to cause the film to begin to develop;
applying radiation to the developing film; and
sensing radiation from the developing film.

41. The method as recited in claim 40, further comprising:
attaching a leading edge of the leader strip to a trailing edge of the film strip to form a continuous loop.

42. The method as recited in claim 41, further comprising:
attaching a leading edge of a second leader strip to the trailing edge of the film strip.

43. A digital film development system, comprising:
a splicer configured to attach a leader strip to a film strip;
a film transport system configured to move the leader strip and attached film strip;
a developer dispenser adapted to apply developer to the film strip;
a radiation source configured to apply radiation to the developing film; and
a sensor adapted to sense radiation from the developing film and to create a digital image file from the sensed radiation.

44. The digital film development system as recited in claim 43, further comprising:
a second radiation source configured to apply radiation to the developing film during a second film development time;
a second sensor adapted to sense radiation from the developing film during the second film development time and to create a second digital image file from the sensed radiation; and
an image processor adapted to combine the first and second digital image files into a final digital image file.

45. A film transport system comprising:
a photographic film strip having sprocket holes near opposing edges of the film strip;
a leader strip narrower than the photographic film strip and attached to a lead end of the photographic film strip;
a pair of oppositely disposed sprockets having teeth engaging the sprocket holes on the photographic film strip; and
a roller connecting the sprockets and supporting the leader strip.

46. The transport mechanism as recited in claim 45, wherein the roller has an arcuate surface.

47. The transport mechanism as recited in claim 45, wherein the roller is adapted to automatically center the leader strip.

48. A digital film development system, comprising:
a developer dispenser configured to apply developer to a film;
a source configured to apply radiation to the developing film;
a sensor configured to sense radiation from the developing film; and
a single drive mechanism adapted to move the developing film past the source and sensor.

49. The system as recited in claim 48, wherein the single drive mechanism comprises:
a motor; and
a roller configured to rotate by movement of the motor.

50. The system as recited in claim 49, wherein the single drive mechanism is configured to pull the film past the source and sensor.

51. The system as recited in claim 48, wherein the drive mechanism comprises a capstan drive.

52. The system as recited in claim 48, further comprising:
a resistance mechanism spaced from the drive mechanism and adapted to contact the film and provide resistance to the movement of the developing film such that the film is tensioned between the drive mechanism and the resistance mechanism.
